(19) United States
(12) Patent Application Publication
(10) Pub. No.: US 2023/0227743 A1
(43) Pub. Date: Jul. 20, 2023

(54) METHOD FOR PRODUCING FUEL USING RENEWABLE METHANE

(71) Applicant: Iogen Corporation, Ottawa (CA)

(72) Inventor: Patrick J. Foody, Ottawa (CA)

(21) Appl. No.: 17/996,497

(22) PCT Filed: Apr. 30, 2021
(86) PCT No.: PCT/CA2021/050600

§ 371 Date: Oct. 18, 2022

Related U.S. Application Data
(60) Provisional application No. 63/018,032, filed on Apr. 30, 2020.

(51) Int. Cl. C10L 1/08; C10L 1/06; C01B 3/38; C10G 49/00

(52) U.S. Cl. CPC C10L 1/08; C01B 3/384; C10G 49/007; C10L 1/06; C01B 2203/043; C01B 2203/062; C01B 2203/0233; C01B 2203/0415; C01B 2203/0475; C01B 2203/0827; C01B 2203/1241; C10G 2300/1025; C10G 2400/02; C10G 2400/04; C10G 2400/08; C10L 2200/043; C10L 2200/0423; C10L 2200/0446; C10L 2200/0469

(57) ABSTRACT

A method of producing fuel that includes providing a feed comprising natural gas, a portion of which is renewable natural gas, to a steam methane reformer in a hydrogen production unit. The feed includes a first portion that is converted to syngas and a second portion that passes through the steam methane reformer unconverted. The unconverted feed is directed to one or more burners of the steam methane reformer as fuel. The renewable natural gas is apportioned such that the first portion of the feed, which is feedstock, has a larger renewable fraction than the second portion, which is fuel. Apportioning a higher renewable fraction to the portion of the feed that is converted increases the yield of renewable content.

### TECHNICAL FIELD

The present invention generally relates to a method and/or system for producing one or more fuels using renewable methane, and more specifically, to a method and/or system for producing one or more fuels in a fuel production process that includes steam methane reforming of a gas containing renewable methane.

### BACKGROUND

Steam methane reforming (SMR) is a common pathway to supply hydrogen. In conventional steam methane reforming, natural gas (NG) is exposed to a catalyst at high temperature and high pressure, thereby promoting a catalytic reaction wherein methane (CH₄) and steam are converted to carbon monoxide (CO) and hydrogen (H2) according to the following reaction.

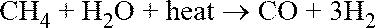

Additional hydrogen can be obtained by reacting the carbon monoxide with water in a water gas shift (WGS) reaction to form carbon dioxide and more hydrogen, as follows.

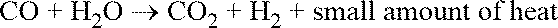

A hydrogen production unit typically includes one or more reactors configured to promote these reactions and produce syngas. The term “syngas” refers to synthesis gas, which is a gas mixture that contains varying amounts of hydrogen (H₂) and carbon monoxide (CO), and often some carbon dioxide (CO₂). A hydrogen production unit typically also includes a purification system to remove carbon oxide impurities (e.g., by pressure swing adsorption) to provide a relatively pure hydrogen product.

Hydrogen is increasingly used in the production of fuels (e.g., liquid transportation fuels). For example, hydrogen is used in oil refineries in the hydroprocessing of crude oil and/or crude oil derived liquid hydrocarbon (e.g., to produce fuels such as gasoline, jet fuel, and diesel). In U.S. Pats. 8,658,026, 8,753,854, 8,945,373, 9,040,271, 10,093,540, and 10,421,663, Foody discloses a method of producing fuel wherein renewable hydrogen hydrogenates crude oil derived liquid hydrocarbon. In this approach, gasoline, diesel, and/or jet fuel having renewable content can be produced using existing fuel production facilities (e.g., an oil refinery). The term “renewable content”, as used herein, refers the portion of the fuel or fuels produced, that is recognized and/or qualifies as renewable (e.g., a biofuel) under applicable regulations.

### SUMMARY

The instant disclosure describes a fuel production process for producing one or more fuels that includes methane reforming (e.g., steam methane reforming), wherein the feed to the methane reformer includes (e.g., is allocated) both renewable methane (e.g., RNG) and non-renewable methane (e.g., fossil-based natural gas). Advantageously, the method and/or system disclosed increases the renewable content produced from the fuel production process for a given amount of renewable methane (e.g., kJ).

In accordance with one aspect of the instant invention there is provided a method of producing fuel comprising: (a) providing natural gas for a fuel production process, said natural gas comprising renewable natural gas and non-renewable natural gas, said fuel production process comprising reacting hydrogen with one or more reactants, at least a portion of the hydrogen being produced in a hydrogen production unit comprising a steam methane reformer; (b) providing a feed comprising at least a portion of the natural gas to the steam methane reformer, said feed comprising a first portion that is converted to syngas and a second portion that passes through the steam methane reformer unconverted; (c) directing the second portion of the feed that passes through the steam methane reformer to one or more burners of the steam methane reformer; (d) apportioning the renewable natural gas such that the first portion of the feed has a larger renewable fraction than the second portion of the feed, and (e) producing a volume of fuel having renewable content from the fuel production process, wherein the yield of renewable content is dependent on the first portion of the feed being apportioned a larger renewable fraction than the second portion of the feed.

In accordance with one aspect of the instant invention there is provided a method of producing one or more fuels, the method comprising: (a) providing natural gas for a fuel production process, said natural gas comprising renewable methane and non-renewable methane, said fuel production process comprising reacting hydrogen with one or more reactants, at least a portion of the hydrogen being produced from a hydrogen production unit comprising a steam methane reformer; (b) determining a flow rate of the natural gas fed to the steam methane reformer as feed; (c) determining a flow rate of a purge gas, a product gas, or a combination thereof produced from the hydrogen production unit; and (d) producing a volume of fuel having renewable content from the fuel production process, wherein the natural gas fed to the steam methane reformer as feed includes a first portion that is converted to syngas and a second portion that passes through the steam methane reformer unconverted, and wherein the method comprises establishing a renewable content of the fuel produced in step (d) in dependence on the first portion being apportioned a higher renewable fraction than the second portion and in dependence on the flow rates determined in step (b) and (c).

In accordance with one aspect of the instant invention there is provided a method comprising: (a) providing natural gas that is processed in a hydrogen production unit to produce hydrogen, said hydrogen production unit comprising steam methane reforming, said natural gas comprising renewable natural gas and non-renewable natural gas, said hydrogen used in a fuel production process for producing one or more fuels, said fuel production process comprising: (i) combining hydrogen produced from the hydrogen production unit with crude oil derived liquid hydrocarbon in a reactor under conditions to hydrogenate the crude oil derived liquid hydrocarbon, and (ii) providing a liquid transportation fuel comprising the hydrogenated crude oil derived liquid hydrocarbon, said natural gas provided as feed for the steam methane reforming, said feed comprising a first portion that is converted to syngas and a second portion that passes through the steam methane reforming unconverted; (b) apportioning the renewable natural gas such that the first portion of the feed has a larger renewable fraction than the second portion of the feed; and (c) establishing a renewable content of the liquid transportation fuel in dependence on step (b), said establishing comprising: (i′) determining a flow rate of the natural gas fed to the hydrogen production unit as feed; and (ii′) determining a flow rate of a purge gas, a product gas, or a combination thereof produced by the hydrogen production unit.

In accordance with one aspect of the instant invention there is provided a method of producing one or more fuels comprising: (a) providing natural gas for a fuel production process, said natural gas comprising renewable methane and non-renewable methane, said fuel production process comprising reacting hydrogen with crude oil derived liquid hydrocarbon, at least a portion of the hydrogen being produced from a hydrogen production unit comprising a steam methane reformer; (b) determining a flow rate of the natural gas fed to the steam methane reformer as feed; (c) determining a flow rate of a purge gas, a product gas, or a combination thereof produced from the hydrogen production unit; and (d) producing a volume of fuel having renewable content from the fuel production process, therein the natural gas fed to the steam methane reformer as feed includes a first portion that is converted to syngas and a second portion that passes through the steam methane reformer unconverted, and wherein the volume of the fuel, a renewable content of the fuel, or a combination thereof, is dependent on the flow rates determined in step (b) and (c) and on the first portion being apportioned a higher renewable fraction than the second portion.

In accordance with one aspect of the instant invention there is provided a fuel having renewable content produced according to any of the methods disclosed herein.

### BRIEF DESCRIPTION OF THE DRAWINGS

FIG. 1 is a simplified diagram of a hydrogen production unit using SMR;

FIG. 2 illustrates a method according to one embodiment of the invention;

FIG. 3 illustrates a method according to one embodiment of the invention;

FIG. 4 illustrates a method according to one embodiment of the invention;

FIG. 5 is a schematic diagram illustrating a system in accordance with one embodiment of the invention;

FIG. 6 illustrates a method according to one embodiment of the invention;

FIG. 7 is a schematic diagram of a system in which one or more fuel(s) having renewable content can be produced in accordance with one embodiment of the invention.

Certain exemplary embodiments of the invention now will be described in more detail, with reference to the drawings, in which like features are identified by like reference numerals. The invention may, however, be embodied in many different forms and should not be construed as limited to the embodiments set forth herein.

### DETAILED DESCRIPTION

The terminology used herein is for the purpose of describing certain embodiments only and is not intended to be limiting of the invention. For example, as used herein, the singular forms “a,” “an,” and “the” may include plural references unless the context clearly dictates otherwise. The terms “comprises”, “comprising”, “including”, and/or “includes”, as used herein, are intended to mean “including but not limited to.” The term “and/or”, as used herein, is intended to refer to either or both of the elements so conjoined. The phrase “at least one” in reference to a list of one or more elements, is intended to refer to at least one element selected from any one or more of the elements in the list of elements, but not necessarily including at least one of each and every element specifically listed within the list of elements. Thus, as a nonlimiting example, the phrase “at least one of A and B” may refer to at least one A with no B present, at least one B with no A present, or at least one A and at least one B in combination. The terms “cause” or “causing”, as used herein, may include arranging or bringing about a specific result (e.g., a withdrawal of a gas), either directly or indirectly, or to play a role in a series of activities through commercial arrangements such as a written agreement, verbal agreement, or contract. The term “associated with”, as used herein with reference to two elements (e.g., a fuel credit associated with the transportation fuel), is intended to refer to the two elements being connected with each other, linked to each other, related in some way, dependent upon each other in some way, and/or in some relationship with each other. The term “plurality”, as used herein, refers to two or more. Unless defined otherwise, all technical and scientific terms used herein have the same meanings as commonly understood by one of ordinary skill in the art.

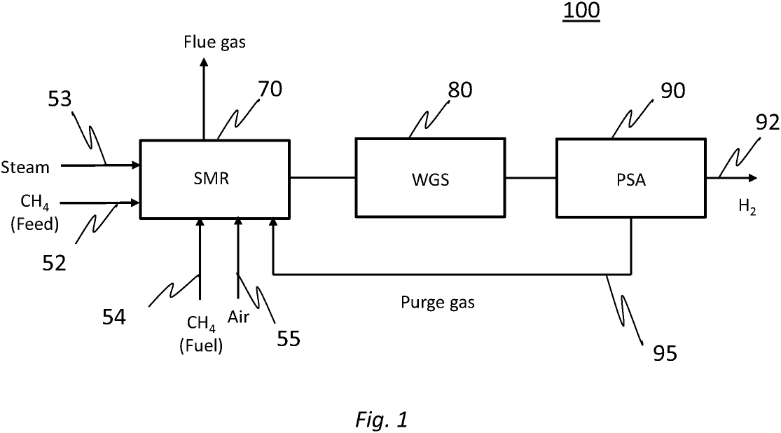

Referring to FIG. 1, there is shown an embodiment of a hydrogen production unit 100 having a steam methane reformer 70, a water gas shift reactor 80, and a pressure swing adsorption (PSA) system 90. A methane-containing feed 52 (e.g., natural gas withdrawn from a natural gas distribution system), which may be desulfurized (not shown), is fed, along with steam 53, into the reactor tube(s) of the steam methane reformer 70, which contain a reforming catalyst. A methane-containing fuel 54 (e.g., natural gas withdrawn from a natural gas distribution system) and combustion air 55 are fed into the burner(s) of the steam methane reformer 70, which fire into the reactor section to provide the heat required for the endothermic reaction (Eq. 1). The syngas produced in the steam methane reformer 70 is fed to a water gas shift reactor 80 to increase the yield of hydrogen. The syngas provided by the water gas shift reactor 80 (e.g., a shifted gas) is purified in the PSA system 90, which produces a hydrogen product stream 92 (e.g., >99% H₂) and a purge stream 95. The purge stream 95, which may contain unconverted methane (CH₄), hydrogen (H₂), carbon dioxide (CO₂), and/or carbon monoxide (CO), is fed back to the burners of the steam methane reformer 70, where it is combusted. More specifically, the purge stream 95 is combusted together with the methane containing fuel 54. Since the purge stream contains some fuel (e.g., CPU, CO, and/or H₂), less fuel gas 54 is required.

When the methane-containing feed 52 for the steam methane reformer 70 contains renewable methane and/or renewable methane is allocated to the feed or a portion thereof (e.g., when the feed contains RNG), then the hydrogen production unit 100 can produce renewable hydrogen. Advantageously, when the renewable methane and/or renewable hydrogen produced using the renewable methane, is feedstock for a fuel production process that produces one or more fuels, one or more of the fuels produced can have renewable content (e.g., the fuel can be recognized as renewable or partially renewable, or a portion of the fuel can be recognized as renewable or partially renewable, under applicable regulations). Unfortunately, in the hydrogen production unit illustrated in FIG. 1, some of the methane provided as feed for the hydrogen production unit passes through the reforming tubes but is not converted to syngas according to Eq. 1. Accordingly, without allocating all of the renewable methane and/or RNG to the part of the feed that is converted to syngas, some of the renewable methane and/or RNG will be combusted and will not be converted to renewable hydrogen.

The instant inventor has recognized that the yield of renewable hydrogen can be increased (e.g., maximized), for a given amount of renewable methane, by allocating the renewable methane and/or RNG within the hydrogen production process as described herein. More specifically, it has been recognized that when the feed for the methane reforming includes and/or is allocated both renewable methane (e.g., includes RNG) and non-renewable methane (e.g., includes fossil based natural gas), the renewable methane can be allocated such that the part of the feed that is converted to syngas has a different renewable fraction than the part of the feed that is unconverted (i.e., passes through the reforming tubes but is not converted to syngas). Advantageously, this can increase the yield of renewable content of one or more fuels produced using the renewable methane (e.g., increase the yield of renewable hydrogen and/or increase the yield of renewable content for one or more liquid transportation fuels produced from the fuel production process).

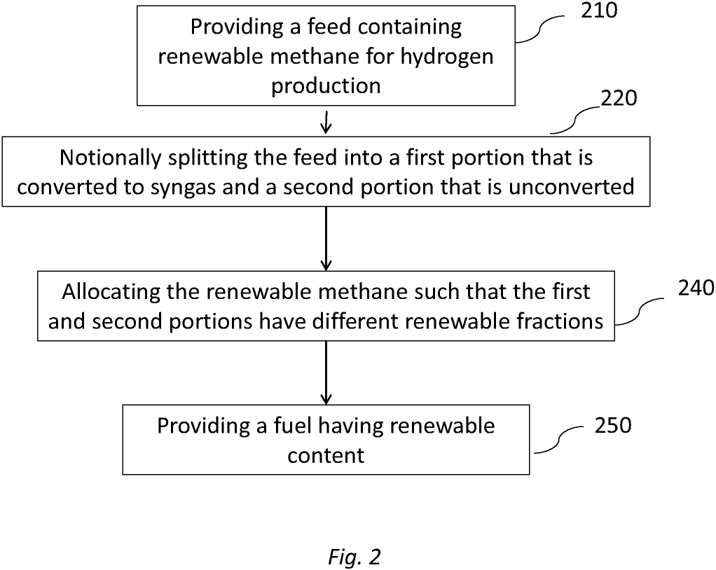

Referring to FIG. 2, there is shown a method according to one embodiment of the instant invention. The method includes providing a feed containing renewable methane and non-renewable methane for a hydrogen production process 210 (e.g., a stream of natural gas, a portion of which is RNG), notionally splitting the feed into a first portion (e.g., MJ/hr) that is converted to syngas during the methane reforming and a second portion (e.g., MJ/hr) that is unconverted (e.g., passes through the methane reforming tubes but is not converted to syngas) 220, allocating the renewable methane and/or RNG such that the first and second portions have different renewable fractions 240, and providing a volume of fuel having renewable content 250, where the volume of fuel and/or renewable content is dependent on the renewable methane and/or RNG being allocated such that the first and second portions have different renewable fractions.

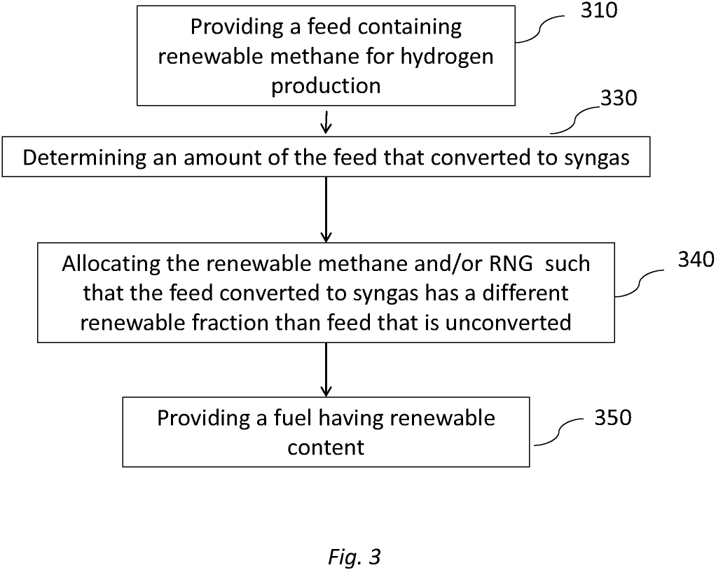

Referring to FIG. 3, there is shown a method according to one embodiment of the instant invention. The method includes providing a feed containing renewable methane and non-renewable methane for a hydrogen production process 310 (e.g., a stream of natural gas, a portion of which is RNG), determining an amount of the feed (e.g., in MJ/hr) that is converted to syngas during the methane reforming and/or an amount of the feed (e.g., in MJ/hr) that is unconverted (e.g., passes through the methane reforming tubes but is not converted to syngas) 330, allocating the renewable methane and/or RNG such that feed converted to syngas has a different renewable fraction than feed that is unconverted 340, and providing a volume of fuel having renewable content 350, where the volume of fuel and/or renewable content is dependent on the renewable methane and/or RNG being allocated such that the feed converted to syngas has a different renewable fraction than the feed that is unconverted 340. Advantageously, since this embodiment includes determining an amount of feed that is converted to syngas, the amount of renewable methane (e.g., in MJ/hr) provided and/or allocated to the hydrogen production unit can be selected in dependence on the determined amount of the feed that is converted to syngas.

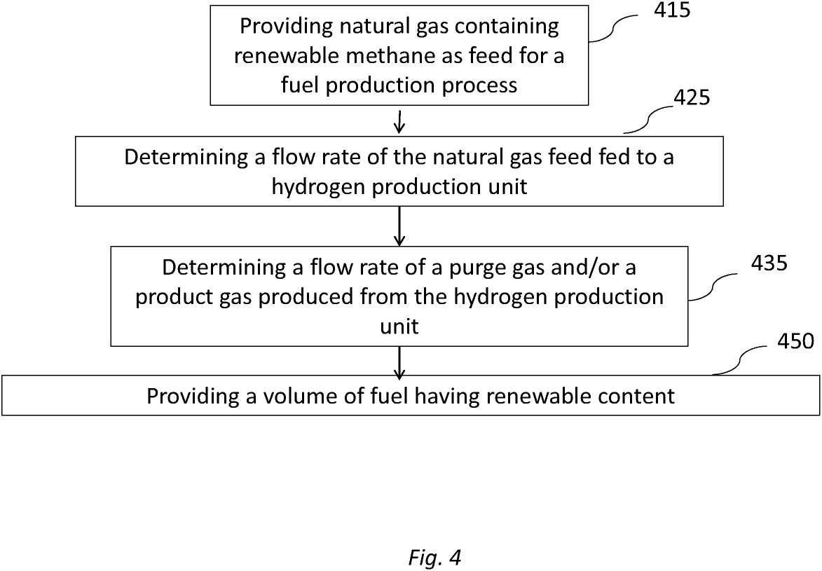

Referring to FIG. 4, there is shown a method according to one embodiment of the instant invention. The method includes providing natural gas as feed for a fuel production process (i.e., a fraction of which is renewable) 415, determining a flow rate of the natural gas feed fed to a hydrogen production unit (e.g., in MJ/hr) 425, determining a flow rate of a purge gas and/or a product gas produced from the hydrogen production unit (e.g., in MJ/hr) 435, and providing a volume of a fuel having renewable content 450. In this embodiment, the volume of the fuel and/or the renewable content of the fuel, is dependent on a calculated renewable content, which is determined using the flow rates determined in steps 425 and/or 435, and which is dependent on a first portion of the natural gas provided as feed to the hydrogen production unit being converted to syngas and a second portion of the natural gas provided as feed to the hydrogen production unit passing through the methane reformer unconverted (i.e., passes through the methane reforming tubes but is not converted to syngas), wherein the first portion of natural gas and the second portion of natural gas have different renewable fractions. For example, in one embodiment, the first portion has a higher renewable fraction than the second portion.

The embodiments illustrated in FIGS. 2-4 take advantage of the fact that the renewable methane and non-renewable methane have different environmental attributes, and that these attributes can be allocated differently within a hydrogen production process based on steam methane reforming. In recognizing that a portion of the feed fed to the steam methane reformer will pass through the steam methane reformer unchanged (i.e., is not converted to syngas), and that the renewable methane and/or the environmental attributes of the renewable methane provided for the fuel production process can be allocated to a portion of the feed that undergoes specific reactions (e.g., SMR) and/or does not undergo specific reactions, the method can be optimized to increase (e.g., maximize) the yield of renewable hydrogen and/or the yield of renewable content of one or more fuels produced from the fuel production process, wherein a feedstock to the process is the renewable methane and/or the renewable hydrogen. Alternatively, or additionally, the renewable methane and/or its environmental attributes can be allocated to decrease the carbon intensity of the renewable hydrogen and/or the renewable content of one or more fuels produced from the fuel production process.

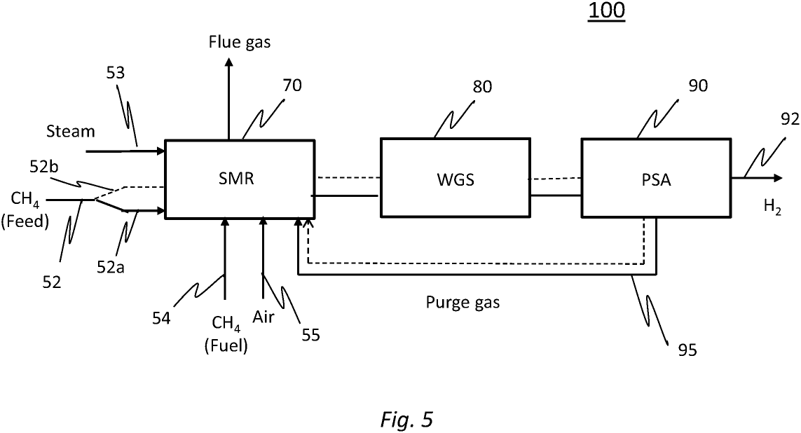

Referring to FIG. 5, there is shown a schematic diagram wherein the methane-containing feed gas 52 (e.g., natural gas withdrawn from natural gas distribution system) for the hydrogen production unit 100 is notionally split into a first portion 52a and a second portion 52b. The first portion 52a is converted to syngas in the steam methane reformer and is subjected to the WGS reaction to increase the hydrogen content of the syngas. The syngas is purified via PSA to provide the hydrogen product 92. The second portion 52b passes through the methane reformer and WGS reactor unconverted (i.e., passes through the methane reforming tubes but is not converted to syngas), and is recycled back to the methane reformer in the purge gas produced by the PSA system 90 (e.g., see dotted line). This unreacted feed is combusted together with any carbon monoxide and/or hydrogen in the purge gas and/or any fuel gas 54 (e.g., natural gas withdrawn from a natural gas distribution system), in the combustion chamber of the methane reformer. In this embodiment, the methane containing feed 52 contains renewable methane (e.g., the methane containing feed can be natural gas withdrawn from a natural gas distribution system, a portion of which is RNG), and the renewable methane and/or RNG is allocated such that the first 52a and/or second portions 52b of the feed 52 have different renewable fractions.

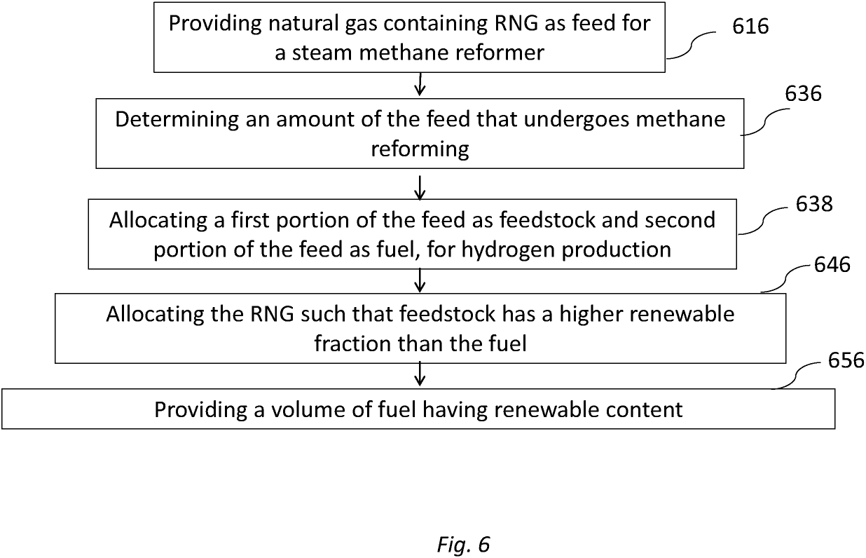

Referring to FIG. 6, there is shown a method according to one embodiment of the invention (e.g., based on the use a hydrogen production unit as illustrated in FIG. 5). The method includes providing natural gas, a fraction of which is RNG, as feed for the steam methane reforming (e.g., in MJ/hr) 616, determining an amount of the feed (e.g., in MJ/hr or as a fraction of the feed) that is converted to syngas 636, allocating a first portion of the feed (e.g., MJ/hr or a fraction of the feed) as feedstock for the hydrogen production process (i.e., the portion of the feed that is converted to syngas) and a second portion of the feed (e.g., MJ/hr or a fraction of the feed) as fuel for the hydrogen production process (i.e., the portion of the feed that is unconverted) 638, allocating the RNG in the feed such that the first portion (i.e., the feedstock) has a larger renewable fraction than the second portion (i.e., the fuel) 646, and providing a volume of fuel having renewable content 656, where the volume of fuel and/or renewable content is dependent on RNG being allocated such that the first portion (i.e., the feedstock) has a higher renewable fraction than the second portion (i.e., the fuel).

Advantageously, since at least portion of the RNG in the feed to hydrogen production process is allocated as feedstock (e.g., for hydrogen production and/or the fuel production process), the renewable hydrogen and/or any fuel produced therefrom can be recognized as having renewable content under applicable regulations. The term “feedstock”, as used herein, refers to material entering a production process that contributes atoms to any product of the production process or is deemed to contribute atoms to any product (e.g., a fuel product).

Further advantageously, since the RNG is allocated such that the first portion (i.e., the feedstock) has a higher renewable fraction than the second portion (i.e., the fuel), the yield of renewable hydrogen and/or renewable content of the fuels can be increased (e.g., maximized). Accordingly, this embodiment, maximizes the number and/or value of fuel credits that can be generated for the fuel(s) produced. In addition, this embodiment, can facilitate the fuel(s) meeting certain lifecycle GHG emission thresholds.

In various embodiments described herein, the second portion of the feed that passes through the steam methane reformer unconverted is separated from the hydrogen produced by steam methane reforming using PSA and is directed to the burners of the steam methane reformer in the purge gas. However, in other embodiments, the second portion of the feed that passes through the steam methane reformer unconverted is separated from the hydrogen produced by steam methane reforming using another hydrogen purification technique and is directed to the burners of the steam methane reformer in an off gas produced from the hydrogen purification.

In various embodiments described herein, the renewable natural gas is described as being allocated such that two portions of the feed have different renewable fractions and/or one portion has larger renewable fraction than the other portion. For purposes herein, a renewable fraction can be zero, one, or any number therebetween (e.g., 0.6). For example, in some embodiments, the renewable methane is apportioned such that the portion of the feed to the SMR that is used to fuel the SMR is zero. By the terms “apportioning” and “apportioned”, as used herein, it is meant “allocating” or “allocated”, respectively.

### Renewable Methane

In general, renewable methane is methane produced from biomass. When methane is sourced from biomass, and is not sourced from fossil resources (e.g., buried combustible geologic deposits of organic material), it can be considered a biofuel. While the bulk of existing renewable methane may come from processes that capture gas from the anaerobic digestion (AD) of organic material, it is also possible to produce renewable methane from the gasification of biomass. For example, the gasification of biomass may produce syngas, which may be cleaned up, methanated, and separated into methane and carbon dioxide.

In one embodiment, the renewable methane is produced from biogas. Biogas refers to the gas produced by the anaerobic digestion of organic material. Biogas, which is a mixture of gases, is largely made up of methane and carbon dioxide. The methane in biogas is renewable methane. Biogas may be produced by anaerobic digestion that occurs naturally (e.g., in a landfill) or in an engineered environment (e.g., an anaerobic digester). In one embodiment, the renewable methane is produced from one or more landfills. In one embodiment, the renewable methane is produced from one or more anaerobic digestion facilities. In one embodiment, the renewable methane is produced from manure (e.g., dairy or swine).

In general, the renewable methane can be produced from any suitable biomass. In one embodiment, the renewable methane is produced from (i) agricultural crops, (ii) trees grown for energy production, (iii) wood waste and wood residues, (iv) plants (including aquatic plants and grasses), (v) residues, (vi) fibers, (vii) animal wastes and other waste materials, and/or (viii) fats, oils, and greases (including recycled fats, oils, and greases). In one embodiment, the renewable methane is produced from (i) manure, (ii) agricultural by-products, (iii) energy crops, (iv) wastewater sludge, (v) industrial waste, (vi) source separated organics, and/or (vii) municipal solid waste.

In one embodiment, the renewable methane is produced from waste organic material. The term “waste organic material”, as used herein, refers to organic material used as a feedstock in a waste-to-fuel process, where the feedstock qualifies as a waste or residue for fuel credit generation. Waste organic material includes but is not limited to, residues from agriculture, aquaculture, forestry and fisheries, and includes wastes and processing residues (e.g., organic municipal waste, manure, sewage sludge, waste wood, etc.).

In general, the renewable methane is provided for use in producing one or more fuels (e.g., a transportation fuel). The term “providing” as used herein with respect to an element, refers to directly or indirectly obtaining the element and/or making the element available for use.

In one embodiment, the renewable methane is provided as raw biogas. Raw biogas, which refers to biogas collected at its source (e.g., a landfill or anaerobic digester), is largely composed of methane and carbon dioxide, may also contain hydrogen sulfide (H₂S), water (H₂O), nitrogen (N₂), ammonia (NH₃), hydrogen (H₂), carbon monoxide (CO), oxygen (O₂), siloxanes, volatile organic compounds (VOCs), and/or particulates. Without being limiting, raw biogas may have a methane content between about 35% and 75% (e.g., average of about 60%) and a carbon dioxide content between about 15% and 65% (e.g., average of about 35%). The percentages used to quantify gas composition and/or a specific gas content, as used herein, are expressed as mol%, unless otherwise specified.

In one embodiment, the renewable methane is provided as partially purified biogas. The term “partial purification”, as used herein, refers to a process wherein biogas is treated to remove one or more non-methane components (e.g., CO₂, H₂S, H₂O, N₂, NH₃, H₂, CO, O₂, VOCs, and/or siloxanes) to produce a partially purified biogas, where the partially purified biogas fails to qualify as renewable natural gas (RNG) and/or will be subject to further purification. In one embodiment, the method includes upgrading raw or partially purified biogas provided (e.g., prior to hydrogen production).

In one embodiment, the renewable methane is provided as renewable natural gas (RNG). The term “renewable natural gas” or “RNG”, as used herein, refers to biogas (or another gas containing renewable methane) that has been upgraded to meet or exceed applicable pipeline quality standards and/or specifications, meet or exceed applicable quality specifications for vehicle use (e.g., CNG specifications), and/or a gas that is recognized and/or qualifies as RNG under applicable regulations. For example, the term RNG can refer to natural gas withdrawn from a distribution system that has been assigned environmental attributes associated with a corresponding amount of renewable natural gas, upgraded from biogas, that was injected into the distribution system. Pipeline specifications include specifications required for the biogas for injection into pipeline. Pipeline quality standards or specifications may vary by region and/or country in terms of value and units. For example, pipelines standards may require a methane level that is greater than 95%. In addition, or alternatively, the pipeline standards may refer to the purity of the gas expressed as a heating value (e.g., MJ/m³ or in BTU/standard cubic foot). Pipeline standards may require, for example, that the heating value of RNG be greater than about 950 BTU/scf, greater than about 960 BTU/scf, or greater than about 967 BTU/scf. In the United States (US), RNG and CNG standards may vary across the country.

In one embodiment, the renewable methane is provided as compressed RNG (bio-CNG) or liquefied RNG (bio-LNG). In one embodiment, the renewable methane is provided as RNG withdrawn from a natural gas distribution system. For example, in one embodiment, the renewable methane is provided by withdrawing gas from a natural gas distribution system and reporting at least a portion of the withdrawn gas as dispensed RNG. In one embodiment, the renewable methane is provided by withdrawing gas from a natural gas distribution system, wherein the amount of gas withdrawn (e.g., in MJ) is associated with an equivalent amount of RNG injected into the natural gas distribution system. In one embodiment, the renewable methane is provided by injecting a quantity of RNG into a natural gas distribution system, and withdrawing an equivalent (or lower) amount of gas from the natural gas distribution system, where the withdrawn gas is recognized and/or qualifies as RNG under applicable regulations. The term “distribution system”, as used herein, refers to a single pipeline or interconnected network of pipelines (i.e., physically connected). Distribution systems are used to distribute a product (e.g., natural gas), often from its source to multiple users and/or destinations (e.g., businesses and households). A distribution system can include pipelines owned and/or operated by different entities and/or pipelines that cross state, provincial, and/or national borders, provided they are physically connected. One example of a distribution system is the U.S. natural gas grid, which includes interstate pipelines, intrastate pipelines, and/or pipelines owned by local distribution companies.

In one embodiment, providing the renewable methane includes transporting the renewable methane (e.g., raw biogas, partially purified biogas, or RNG) to the hydrogen production unit(s) and/or fuel production facility in a vessel and/or by pipeline. In one embodiment, where the renewable methane is transported to the hydrogen production unit(s) and/or fuel production facility as RNG, the method includes transporting RNG to the hydrogen production unit(s) and/or fuel production facility as a fungible batch using a natural gas distribution system. When RNG is provided as a fungible batch in a distribution system, a quantity of RNG is injected into the distribution system, where it can comingle with non-renewable methane (derived from fossil sources), and an equivalent quantity (e.g., MJ) of gas is withdrawn at another location. Since the transfer or allocation of the environmental attributes of the RNG injected into the distribution system to gas withdrawn at a different location is typically recognized, the withdrawn gas is recognized as RNG and/or qualifies as RNG under applicable regulations (e.g., even though the withdrawn gas may not contain actual molecules from the original biomass and/or contains methane from fossil sources). Such transfer may be made on a displacement basis, where transactions within the distribution system involve a matching and balancing of inputs and outputs. Typically, the direction of the physical flow of gas is not considered. In one embodiment, the balancing of inputs and/or outputs includes monitoring the energy content and/or energy delivered. The term “energy content”, as used herein, refers to the energy density, and more specifically to the amount of energy contained within a volume of gas (e.g., measured in units of BTU/scf or MJ/m³). Heating value is one example of an energy content measurement. The term “energy delivered”, as used herein, is a measure of the amount of energy delivered to or from the distribution system in a particular time period, or series of time periods (e.g., discrete increments of time), such as, without limitation, hourly, daily, weekly, monthly, quarterly, or yearly intervals. The energy delivered may be obtained after determining values representing the energy content and flow (e.g., volume) for a particular time period. In particular, the energy delivered may be obtained from the product of these two values, multiplied by the time according to the following: Energy delivered (BTU) = Σ ((energy content (BTU/cubic foot) * volume of flow (cubic feet/min)) * number of minutes. In one embodiment, the energy delivered is provided by a meter. The term “batch”, as used herein, refers to a certain amount of the gas (e.g., measured using volume, mass, and/or energy delivered) and does not imply or exclude an interruption in the production and/or delivery.

In one embodiment, the method includes obtaining, generating, or receiving, documentation that evidences that a gas withdrawn from a natural gas distribution system is recognized as and/or qualifies as RNG under applicable regulations. In general, such documentation (e.g., electronic or paper) may vary according to the applicable regulatory agency. In one embodiment, this documentation can include reports indicating a) a quantity of RNG was dispensed from a distribution system, b) a quantity of RNG was injected into the distribution system, c) proof of the origin, d) evidence that the environmental attributes of the injected RNG were transferred, or e) any combination of a-d. In one embodiment, the documentation includes a) one or more attestations, b) proof of sustainability, c) verification statements, d) certificates, e) guarantees of origin, f) chain of custody evidence, and/or g) approved fuel pathways.

In one embodiment, the method includes obtaining, generating, or receiving documentation issued by a regulatory agency or by a third party (e.g., an entrusted and/or accredited individual or body). For example, some regulatory agencies may entrust and/or accredit one or more verification, validation, and/or certification bodies to confirm that that specific fuels are sourced at least in part from renewable material and/or that at least a portion of the fuel qualifies as a renewable fuel under the applicable regulations. Verification refers to a systematic, independent, and documented process for evaluating reported data against regulation requirements. An accredited verification body may provide validation or verification statements and/or validation or verification services. A certification body may provide certificates (e.g., green gas certificates or biogas certificates). For example, the ISCC - EU is a certification system to demonstrate compliance with the legal sustainability requirements specified in the RED of the European Commission. Verification of compliance with the ISCC requirements, as well as issuance of ISCC certificates, can be performed by recognized third-party certification bodies cooperating with ISCC.

In one embodiment, the method includes providing renewable methane for use in producing one or more fuels from a fuel production process that includes hydrogen production, wherein providing the renewable methane includes withdrawing RNG from a natural gas distribution system and/or allocating RNG withdrawn from a natural gas distribution system. The term “renewable methane”, as used herein, refers to methane in biogas (raw or partially purified), methane in RNG, and/or methane that is recognized as and/or qualifies as renewable under applicable regulations. Establishing that a gas is recognized as and/or qualifies as renewable methane/RNG (e.g., originates from renewable sources) under applicable regulations can depend on whether the gas is transported by truck or by pipeline and the practices and requirements of the applicable regulatory agency, where such practices may include, for example, the use of chain of custody accounting methods such as identity preservation, book-and-claim, and a mass balance system.

In one embodiment, the renewable methane is provided in a feedstock for the hydrogen production and/or the fuel production process. In one embodiment, the feedstock contains raw biogas, partially purified biogas, or RNG. In one embodiment, the feedstock is natural gas withdrawn from a natural gas distribution system, a fraction of which is recognized as and/or qualifies as RNG under applicable regulations.

In one embodiment, a feedstock for the fuel production process is provided by withdrawing a gas from a natural gas distribution system, wherein a fraction of the withdrawn gas is recognized as and/or qualifies as RNG under applicable regulations. In one embodiment, the method includes allocating the RNG to the hydrogen production unit. In one embodiment, the method includes allocating the RNG to the hydrogen production unit.

### Hydrogen Production

In general, the renewable methane is provided for use in a fuel production process that includes hydrogen production (e.g., produces hydrogen from one or more hydrogen production units). The term “hydrogen production unit”, as used herein, refers to a system or combination of systems primarily used for production of hydrogen from a methane containing gas (e.g., natural gas).

In general, at least a portion of the hydrogen is produced from a hydrogen production unit that includes a methane reformer and a hydrogen purification system. The methane reformer and/or hydrogen purification system can be based on any suitable technology. In one embodiment, the methane reformer includes one or more reactors configured to promote a steam methane reforming (SMR), autothermal reforming (ATR), partial oxidation (POX), and/or dry methane reforming (DMR) reaction.

In a preferred embodiment, the methane reformer includes a steam methane reformer. A steam methane reformer includes one or more reactors configured to support the SMR reaction of Eq. (1) and may provide for the WGS reaction of Eq. (2). For example, a steam methane reformer typically includes one or more reforming tubes filled with catalyst, which are surrounded by a combustion chamber. The heat required for the catalytic reforming of Eq. (1) is typically provided by feeding a fuel to one or more burners that fire into the combustion chamber such that combustion of the fuel outside the tubes heats the gas passing through the tubes. Without being limiting, the catalyst may be nickel-based. Optionally, the catalyst is supported on a support of suitable material (e.g., alumina, etc.). Optionally, promoters (e.g., MgO) are added. Without being limiting, conventional steam methane reformers may operate at pressures between 200 and 600 psig and temperatures between about 450 to 1000° C.

In one embodiment, the hydrogen production unit includes one or more water gas shift (WGS) reactors (i.e., in addition to the methane reformer and the hydrogen purification system). For example, in the SMR reaction discussed with regard to Eq. 1, the SMR catalyst may be active with respect to the WGS reaction in Eq. 2. For example, the gas leaving the steam reformer may be in equilibrium with respect to the WGS reaction. However, syngas leaving the steam methane reformer typically contains a significant amount of carbon monoxide that can be converted to hydrogen (i.e., in a WGS reaction). Since the WGS reaction is exothermic, cooling of the syngas over a selected catalyst may promote the WGS reaction, and thus may increase the H₂ content of the syngas while decreasing the CO content. Accordingly, it may be advantageous to provide one or more WGS reactors (i.e., shift reactors) downstream of the methane reforming. In general, shift reactors may use any suitable type of shift technology (e.g., high temperature shift conversion, medium temperature shift conversion, low temperature shift conversion, sour gas shift conversion, or isothermal shift). For example, WGS reactions may be conducted at temperatures between 320-450° C. (high temperature) and/or between 200-250° C. (low temperature). Without being limiting, high temperature thermal shift may be conducted with an iron oxide catalyst (e.g., supported by chromium oxide), whereas low temperature thermal shift may be conducted with a Cu/ZnO mixed catalyst. Optionally, a promoter is added. In general, there may be one or more stages of WGS to enhance the hydrogen concentration in the syngas. For example, the WGS may be conducted in a high temperature WGS reactor (e.g., 350° C.) followed by a low temperature WGS reactor (e.g., 200° C.). Without being limiting, the syngas from the SMR and/or WGS reactor (e.g., which may be at about 210-220° C.) can be cooled (e.g., to 35-40° C.), and the condensate separated, prior to hydrogen purification.

The hydrogen purification system is based on any suitable hydrogen purification process or combination of processes that treats the syngas from the methane reforming and/or WGS to separate some of the hydrogen from some of the carbon dioxide, carbon monoxide, methane and/or any other impurities in the syngas, and to provide a stream enriched in hydrogen (i.e., containing at least 80% hydrogen). For example, in one embodiment, the hydrogen purification system is configured to remove carbon dioxide and/or unreacted methane from the syngas. Without being limiting, some examples of suitable hydrogen purification processes for the hydrogen purification include a) absorption, b) adsorption, c) membrane separation, d) cryogenic separation, and e) methanation.

Absorption processes that remove carbon dioxide may include scrubbing with a weak base (e.g., hot potassium carbonate) or an amine (e.g., ethanolamine). For example, carbon dioxide may be captured using a monoethanolamine (MEA) system or a methyl-diethanolamine (MDEA) system. An MEA system may include one or more absorption columns containing an aqueous solution of MEA at about 30 wt%. The outlet liquid stream of solvent may be treated to regenerate the MEA and separate carbon dioxide.

Adsorption processes may use an adsorbent bed (e.g., molecular sieves, activated carbon, active alumina, or silica gel) to remove impurities such as methane, carbon dioxide, carbon monoxide, nitrogen, and/or water from the syngas. More specifically, these impurities may be preferentially adsorbed over hydrogen, yielding a relatively pure hydrogen stream. Moreover, since the impurities may be adsorbed at higher partial pressures and desorbed at lower partial pressures, the adsorption beds may be regenerated using pressure. Such systems /processes are typically referred to as pressure swing adsorption (PSA) systems/processes. In general, PSA systems may be the most common hydrogen purification processes used in hydrogen production units. Some adsorption beds may be regenerated with temperature.

Membrane separation is based on different molecules having varying permeability through a membrane. More specifically, some molecules, referred to as the permeant(s) or permeate, diffuse across the membrane (e.g., to the permeate side). Other molecules do not pass through the membrane and stay on the retentate side. The driving force behind this process is a difference in partial pressure, wherein the diffusing molecules move from an area of high concentration to an area of low concentration. For hydrogen purification, the permeable gas typically is hydrogen. While hydrogen separation through a membrane may have a relatively high recovery rate, this may come at the expense of reduced purity.

Cryogenic separation is based on the fact that different gases may have distinct boiling/sublimation points. Cryogenic separation processes may involve cooling the product gas down to temperatures where the impurities condense or sublimate and can be separated as a liquid or a solid fraction, while the hydrogen accumulates in the gas phase. For example, cryogenic separations may use temperatures below -10° C. or below -50° C.

Methanation is a catalytic process conducted to convert the residual carbon monoxide and/or carbon dioxide in the syngas to methane, according to the following.

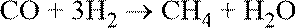

Since the methanation reaction consumes hydrogen, it can be advantageous to provide a carbon dioxide removal step prior to the methanation step.

In a preferred embodiment, the hydrogen purification system produces an off-gas containing methane and/or natural gas that can be recycled back to the methane reformer as fuel. For example, in one embodiment, the hydrogen production unit includes a PSA system that produces a purge gas containing carbon dioxide, carbon monoxide, methane, and/or hydrogen. In addition to producing a hydrogen product stream that can be about 99.9% hydrogen, this configuration advantageously allows the hydrogen, carbon monoxide, and unconverted methane in the purge gas to be used as a fuel for the burners of the methane reformer.

In one embodiment, the hydrogen production unit includes one or more additional systems for hydrogen production (i.e., in addition to the methane reformer and hydrogen production system). For example, conventional hydrogen production units may include a feedstock purification stage, a pre-reforming stage, and/or one or more boilers to generate steam. A purification system may be provided to remove sulfur, chloride, olefin, and/or other compounds from natural gas, which may be detrimental to downstream reforming catalysts (e.g., may include a desulfurization unit). A pre-reforming system may allow a higher inlet feed temperature with minimal risk of carbon deposition. In one embodiment, the hydrogen production unit includes a biogas cleaning and/or biogas upgrading system.

In general, the methane-containing feed provided to the hydrogen production unit is and/or or contains natural gas. In one embodiment, the methane-containing feed contains natural gas withdrawn from a natural gas distribution system (e.g., commercial gas grid). The term “natural gas”, as used herein, refers to a mixture of hydrocarbon compounds that is gaseous at standard temperatures and pressures, where the primary component is methane. In general, it is common for methane reformers to be able to convert any of the hydrocarbons present in natural gas to syngas (i.e., not just the methane).

In general, the methane-containing feed will contain renewable methane and/or contain methane to which the environmental attributes of renewable methane have or will be transferred. For example, in one embodiment, the method includes providing a feed for the hydrogen production unit that contains RNG withdrawn from a natural gas distribution system. In one embodiment, the method includes providing the hydrogen production unit with a natural gas feed, where the natural gas is withdrawn from a natural gas distribution system and includes a portion that is recognized as and/or qualifies as RNG under applicable regulations.

When renewable methane is provided in the feed to the hydrogen production unit, the hydrogen production unit can produce renewable hydrogen. The term “renewable hydrogen”, as used herein, refers to hydrogen produced using renewable methane (e.g., using raw biogas, partially purified biogas, and/or RNG) and/or to hydrogen deemed under applicable regulations to be produced using renewable methane. For example, the term “renewable hydrogen”, as used herein, includes hydrogen produced using methane derived from biomass (and not fossil sources) and/or a gas withdrawn from a distribution system that is recognized as and/or qualifies as RNG under applicable regulations.

In one embodiment, the hydrogen production process is part of a fuel production process, and the method includes providing a natural gas feedstock for the fuel production process, a portion of which is recognized as and/or qualifies as RNG under applicable regulations. In this embodiment, the RNG can be physically directed to the hydrogen production unit and/or allocated to the feed to the hydrogen production unit. When renewable methane is provided in a feedstock supplying one or more hydrogen production plants that produce hydrogen for a fuel production process, the fuel production process can produce one or more fuels having renewable content.

### Determining an Amount of the Feed Converted to Syngas

In general, the methane reformer will not convert all of the methane-containing feed to syngas (e.g., a portion of the feed can pass through the reformer tubes without being converted). In one embodiment, the method includes determining an amount of feed fed to the hydrogen production unit that is converted to syngas. In one embodiment, the method includes determining an amount of feed fed to the hydrogen production unit that is unconverted. Feed that is “unconverted” refers to feed that passes through the methane reformer (i.e., is not converted to syngas) and exits the methane reformer unreacted. In one embodiment, the amount of feed converted to syngas is expressed using energy (e.g., MJ/hr). In one embodiment, the amount of feed converted to syngas is expressed as a relative amount (e.g., as a fraction of the total feed provided to the methane reformer).

The amount of feed converted to syngas can be determined by measuring at least one of the products (e.g., hydrogen, carbon monoxide and/or carbon dioxide) and/or measuring the unconverted feed. For example, in the hydrogen production unit illustrated in FIGS. 1 and 5, substantially all of the unconverted feed, carbon monoxide, and carbon dioxide is recycled back to the burners of the steam methane reformer, where at least the hydrocarbons are combusted to produce heat for the methane reforming. Accordingly, monitoring the purge gas can determine how much feed is recycled (e.g., in MJ/hr), and thus not converted, and/or how much carbon monoxide and/or carbon dioxide was produced.

As will be understood by one of ordinary skill in the art, the amount of feed converted to syngas can be determined using any suitable quantification method. In one embodiment, the amount of feed converted to syngas is determined using flow rates of the feed fed into the hydrogen production unit, flow rates of the hydrogen product gas, and/or flow rates of the purge gas produced from the hydrogen production process. In one embodiment, one or more of these flow rates is used in a mass balance or energy balance analysis to determine the amount of feed converted to syngas.

In general, measuring the flow of the feed, hydrogen, and/or purge gas can be achieved using any suitable method/technology in the art. For example, the flow rates can be measured using any suitable metering system, and can be provided as volume, mass, or energy per unit of time. In one embodiment, the flow of natural gas provided as a feed is measured using a natural gas meter that measures the volume of gas passing therethrough, and converts it to energy (e.g., using a heating value) such that it is expressed in MJ/hr. In one embodiment, the flow of feed, hydrogen, and/or purge gas measured as a volume flow rate and/or a mass flow rate, using a suitable flow meter, either continuously or intermittently. As will be understood by those skilled in the art, the frequency of sampling required may depend on how (or if) the values change over time and/or with variabilities in the process conditions (e.g., feedstock).

In one embodiment, an amount of feed converted to syngas is determined using one or more flow rates and/or a compositional analysis of the feed, the hydrogen product, and/or the purge gas. For example, in one embodiment, a compositional analysis is conducted with a gas analyzer (e.g., stand alone or integrated with a metering system). A gas analyzer can measure the energy content of the gas (e.g., from methane and/or other hydrocarbons present in the feed) and/or provide a compositional analysis. For example, a gas analyzer based on gas chromatography can be used to measure CO, CH₄, H₂O, CO₂, etc., contents within in the purge gas. As will be understood by those skilled in the art, the frequency of sampling required may depend on how (or if) the values change over time and/or with variabilities in the process conditions (e.g., feedstock). In one embodiment, determining the composition of a gas (e.g., the purge gas) includes an off-site analysis and/or obtaining a previously measured analysis, which can be applied to more recently measured flow rates (e.g., volume). In one embodiment, the off-site analysis is heating value. In one embodiment, the off-site analysis is a composition analysis.

Advantageously, in determining an amount of feed converted to syngas, and thus the amount of feed that is unconverted, this embodiment facilitates a step of notionally splitting the feed into a first portion converted to syngas (i.e., that is feedstock) and a second other portion that is unconverted (e.g., that is separated out in hydrogen purification and recycled back to the burners of the methane reformer for use as fuel for the methane reforming). More specifically, it facilitates quantifying what amount or fraction of the feed is feedstock for the hydrogen production (i.e., contributes or is deemed to contribute atoms to the products in Eqs. 1 or 2) and/or feedstock for the fuel production process (i.e.., contributes or is deemed to contribute atoms to any product produced from the fuel production process), and/or what amount or fraction of the feed is fuel for the hydrogen production and/or fuel production process.

Further advantageously, the amount of feed converted to syngas can be used in determining how much renewable methane to provide in the feed. For example, in one embodiment, the renewable fraction of the feed is determined in dependence on the determined amount of feed converted to syngas. The term “renewable fraction”, as used herein in respect of an element, refers to the fraction of the element (e.g., a portion of the feed to hydrogen production unit), by energy, that is recognized as and/or qualifies as renewable under applicable regulations. In general, the renewable fraction will be calculated over a given time period (e.g., hour, 3 months). For example, if a stream of natural gas provided as feed is provided at 100 MJ/hr, of which 60 MJ/hr is RNG, then the renewable fraction of the feed is 0.6. In another example, if “X” MJ of natural gas is provided as feed for hydrogen production over a 3-month reporting period, and 0.25*X MJ of renewable natural gas is purchased and allocated as feed for hydrogen production within the same reporting period, then the renewable fraction of the feed for hydrogen production is 0.25.

In one embodiment, the renewable fraction of the feed is selected such that it does not exceed the relative amount of feed determined to be converted to syngas. The term “relative amount of feed determined be converted to syngas”, as used herein, refers to the fraction of the feed, by energy, that is converted to syngas in the methane reforming. In limiting the renewable fraction of the feed to below the relative amount of feed determined to be converted to syngas, all or substantially all of the feed that is recognized as and/or qualifies as renewable under applicable regulations can be used as feedstock for producing the renewable hydrogen and/or a fuel having renewable content.

### Allocating the Renewable Methane

In general, the renewable methane is provided for producing one or more fuels in a fuel production process that includes methane reforming. In one embodiment, the method includes providing the renewable methane (e.g., as RNG) in a feed to the hydrogen production unit. In one embodiment, the method includes providing the renewable methane (e.g., as RNG) in a feedstock for the fuel production process, and allocating the renewable methane and/or RNG as feed to the hydrogen production unit.

The term “allocating”, as used herein in respect of a particular element, refers to designating the element for a specific purpose. For example, an amount of RNG can be allocated as feedstock for a given process, can be allocated as feed for one or more hydrogen production units, and/or can be allocated as a portion of the feed that is converted in methane reforming (e.g., feedstock). In one embodiment, allocating an amount of renewable methane and/or RNG includes assigning its environmental attributes to an equivalent amount of natural gas used within the fuel production process. The term “environmental attributes”, as used herein with regard to a specific material (e.g., renewable methane or RNG), refers to any and all attributes related to the material, including all rights, credits, benefits, or payments associated with the renewable nature of the material and/or the reduction in or avoidance of fossil fuel consumption or reduction in lifecycle greenhouse gas emissions associated with the use of the material. Some non-limiting examples of environmental attributes include verified emission reductions, voluntary emission reductions, offsets, allowances, credits, avoided compliance costs, emission rights and authorizations, certificates, voluntary carbon units, under any law or regulation, or any emission reduction registry, trading system, or reporting or reduction program for greenhouse gas emissions that is established, certified, maintained, or recognized by any international, governmental, or nongovernmental agency.

In general, the renewable methane and/or RNG can be allocated in any amount/ratio that results in the portion of the feed converted to syngas and the portion of the feed that is unconverted having different renewable fractions. In one embodiment, at least a portion of the renewable methane and/or RNG is allocated such that the portion of the feed converted to syngas has a higher renewable fraction than the portion of the feed that is unconverted. In one embodiment, the renewable methane and/or RNG is allocated such that substantially all of the renewable methane and/or RNG provided as feed for hydrogen production is allocated to a portion of the feed that is converted to syngas. In one embodiment, the renewable methane and/or RNG is allocated such that the portion of the feed allocated to be converted to syngas is at least 75%, at least 80%, at least 85%, at least 90%, at least 95%, or about 100% renewable (e.g., is 100% RNG). In one embodiment, an amount of renewable methane or an amount of RNG provided and/or allocated to the feed to the hydrogen production unit is allocated such that at least 51%, at least 55%, at least 60%, at least 70%, at least 75%, at least 80%, or at least 90% of the renewable methane or RNG provided or allocated as feed for the hydrogen production unit is allocated to the portion of the feed that is converted to syngas.

In one embodiment, an amount of renewable methane and/or RNG is allocated so as to increase the yield of renewable hydrogen from the hydrogen production unit for a given quantity of renewable methane and/or RNG and/or increase a yield of renewable content of one or more fuels produced from the fuel production process.

In one embodiment, the yield of renewable hydrogen is calculated based on energy and expressed as an energy yield. The term “energy yield”, as used herein with regard to a specific fuel produced by a process, refers to the energy in the fuel produced by the process (e.g., MJ) divided by the energy in the feedstock(s) fed into the process (e.g., in MJ), for a given time period. The energy in the fuel or each feedstock (in MJ) may, for example, be determined from its mass flow rate (kg/hr) multiplied by its heating value (MJ/kg) and the time period (hr). The energy yield for a fuel may be expressed as a percentage. For hydrogen production, the feedstock is natural gas, and the product is the stream enriched in hydrogen.

For example, consider the following example, wherein an SMR-based hydrogen production unit is configured to produce about 120 MJ/hr of hydrogen for every 100 MJ/hr of natural gas feedstock. In this case, the hydrogen production unit has an energy yield for hydrogen of about 1.2 or 120% (e.g., the calculations do not account for steam and/or the natural gas used to fuel the SMR). If 50 MJ/hr of the natural gas feedstock is RNG, then the hydrogen production process produces 60 MJ/hr of renewable hydrogen and 60 MJ/hr of non-renewable hydrogen. In this case, the energy yield of renewable hydrogen can be determined by multiplying the energy yield for total hydrogen production (i.e., 1.2) by the renewable fraction of the feedstock (i.e., 0.5).

In conventional hydrogen production, all of the feed to the methane reformer (i.e., all of the natural gas fed into the reformer tubes) is treated the same and is not typically segregated into two portions to determine the energy yield. However, as discussed herein, when producing renewable hydrogen using a hydrogen production unit that recycles the unconverted natural gas for use as a fuel for the methane reformers, it can be advantageous to allocate one portion of the feed as feedstock and the remaining portion as fuel for the methane reforming. In particular, designating part of the feed as feedstock and part of the feed as fuel is advantageous when the feed includes renewable methane and when the renewable methane and/or RNG can be allocated to the two portions in different amounts. For example, the amount of renewable methane and/or RNG allocated as feedstock can determine the yield of renewable hydrogen and/or renewable content of one or more fuels produced using the hydrogen, whereas the amount of renewable methane and/or RNG allocated as fuel can determine the carbon intensity of any fuels produced using the hydrogen.

Advantageously, allocating the renewable methane and/or RNG to the portion of the feed converted to syngas (and thus is designated as feedstock for the process) preferentially over the portion of the feed that is unconverted (and thus is designated as a fuel for the process), the renewable fraction of the feedstock increases (e.g., relative to the renewable fraction of the feed), and the yield of renewable hydrogen increases.

In one embodiment, an amount of renewable methane and/or RNG is allocated so as to decrease the carbon intensity of the renewable hydrogen and/or one or more fuels produced from the fuel production process, for a given quantity of renewable methane. For example, in one embodiment, a fraction of the renewable methane and/or RNG is allocated to a portion of the feed that is unconverted and is used as fuel for the methane reforming. Since combusting renewable methane and/or RNG simply returns to the atmosphere carbon that was recently fixed by photosynthesis, and thus is considered relatively benign, this can reduce greenhouse gas emissions from the SMR furnace (e.g., compared to using fossil-based methane). The term “carbon intensity” or “CI” refers to the quantity of lifecycle greenhouse gas emissions, per unit of fuel energy, which is typically expressed in equivalent carbon dioxide emissions (e.g., gCO₂e/MJ or kgCO₂e/MMBtu). As is known to those skilled in the art, the carbon intensity of a fuel is typically determined using a net lifecycle GHG analysis. A lifecycle GHG analysis, which generally evaluates the GHG emissions of a product and thus can contribute to global warming, typically considers GHG emissions of each: (a) the feedstock production and recovery (including if the carbon in the feedstock is of fossil origin (such as with oil or natural gas) or of atmospheric origin (such as with biomass)), direct impacts like chemical inputs, energy inputs, and emissions from the collection and recovery operations, and indirect impacts like the impact of land use changes from incremental feedstock production; (b) feedstock transport (including energy inputs, and emissions from transport); (c) fuel production (including chemical and energy inputs, emissions and byproducts from fuel production (including direct and indirect impacts)); (d) transport and storage prior to use as a transport fuel (including chemical and energy inputs and emissions from transport and storage), and (e) tailpipe emissions. Models for conducting lifecycle GHG emission analyses are known (e.g., GREET model developed by Argonne National Laboratory (ANL)). As will be understood by those skilled in the art, the lifecycle GHG emissions analysis used to determine the carbon intensity of the fuel can vary and be dependent on the applicable regulations (e.g., for fuel credit generation).

### Fuel Production

In general, the renewable methane and/or renewable hydrogen is used for producing one or more fuels. For example, in one embodiment the renewable methane and/or renewable hydrogen is used in a fuel production process to produce one or more transportations fuels. In general, the fuel production process can be any fuel production process that includes methane reforming of natural gas to produce syngas. In one embodiment, the fuel production process produces syngas that is purified to provide a hydrogen product, which is provided as a transportation fuel, or is used in the production of a transportation fuel. For example, in one embodiment, the hydrogen is used in a gas fermentation or a Fischer-Tropsch synthesis. In one embodiment, the hydrogen is used to hydrogenate crude oil derived liquid hydrocarbon. In one embodiment, the hydrogen is used to hydrogenate renewable oils and/or fats.

In a preferred embodiment, the fuel production process includes one or more hydroprocessing steps wherein crude oil derived liquid hydrocarbon is hydrogenated. The term “crude oil derived liquid hydrocarbon”, as used herein, refers to any carbon-containing material obtained and/or derived from crude oil that is liquid at standard ambient temperature and pressure. The term “crude oil”, as used herein, refers to petroleum extracted from geologic formations (e.g., in its unrefined form). Crude oil includes liquid, gaseous, and/or solid carbon-containing material from geologic formations, including oil reservoirs, such as hydrocarbons found within rock formations, oil sands, or oil shale. Advantageously, since a feedstock for the hydrogen production process and/or the fuel production process can contain renewable methane, one or more fuels produced from the process can have renewable content. In one embodiment, the fuel production process produces one or more liquid transportation fuels having renewable content.

In one embodiment, the fuel production process includes one or more hydroprocessing steps wherein crude oil derived liquid hydrocarbon from or at an oil refinery is hydrogenated. Oil refineries (i.e., petroleum refineries) include many unit operations and processes. One of the first unit operations is the continuous distillation of crude oil. For example, crude oil may be desalted and piped through a hot furnace before being fed into a distillation unit (e.g., an atmospheric distillation unit or vacuum distillation unit). Inside the distillation unit, the liquids and vapours separate into fractions in dependence on their boiling point. The lighter fractions, including naphtha, rise to the top, the middle fractions, including kerosene and diesel/heating oil, remain in the middle, and the heavier liquids, often called gas oil, settle at the bottom. After distillation, each of the fractions may be further processed (e.g., in a cracking unit, a reforming unit, alkylation unit, light ends unit, dewaxing unit, coking unit, etc.).

Cracking units use heat, pressure, catalysts, and sometimes hydrogen, to crack heavy hydrocarbon molecules into lighter ones. Complex refineries may have multiple types of crackers, including fluid catalytic cracking (FCC) units and/or hydrocracking units. FCC units (i.e., catalytic crackers or “cat crackers”) are often used to process gas oil from distillation units. The FCC process primarily produces gasoline, but may also produce important by-products such as liquefied petroleum gas (LPG), light olefins, light cycle oil (LCO), heavy cycle oil (HCO), and clarified slurry oil. Hydrocracking units (i.e., hydrocrackers), which consume hydrogen, may be also used to process gas oils from a distillation unit. However, since the hydrocracking process combines hydrogenation and catalytic cracking, it may be able to handle feedstocks that are heavier than those that can be processed by FCC, and thus may be used to process oil from cat crackers or coking units. Hydrocrackers typically produce more middle distillates (e.g., kerosene and/or diesel) than gasoline. Hydrocrackers may also hydrogenate unsaturated hydrocarbons and any sulfur, nitrogen or oxygen compounds (e.g., reduces sulfur and nitrogen levels).

Reforming units (i.e., catalytic reforming units) use heat, moderate pressure, and catalysts to convert heavy naphtha, which typically has a low octane rating, and/or other low octane gasoline fractions, into high-octane gasoline components called reformates. Alkylation units may convert lighter fractions (e.g., by-products of cracking) into gasoline components. Isomerization units may convert linear molecules to higher-octane branded molecules for blending into gasoline or as feedstock to alkylation units.

Hydrotreating units may perform a number of diverse processes including, for example, the conversion of benzene to cyclohexane, aromatics to naphtha, and the reduction of sulfur, oxygen, and/or nitrogen levels. For example, hydrotreating units are often used to remove sulfur from naphtha streams because sulfur, even in very low concentrations, may poison the catalysts in catalytic reforming units. In oil refineries, hydrotreaters are often referred to as hydrodesulfurization (HDS) units. Hydrotreating units may be used for kerosene, diesel, and/or gas oil fractions. For example, hydrotreating units for diesel may saturate olefins, thereby improving the cetane number.

Both hydrotreating and hydrocracking fall within the scope of the term hydroprocessing and consume hydrogen. In general, hydrotreating is less severe than hydrocracking (e.g., there is minimal cracking associated with hydrotreating). For example, the time that the feedstock remains at the reaction temperature and the extent of decomposition of non-heteroatoms may differ between hydrotreating and hydrocracking. Hydroprocessing is typically conducted in a hydroprocessing unit. The term “hydroprocessing unit”, as used herein, refers to one or more systems (e.g., hydrogenation reactor(s), pumps, compressor(s), separation equipment, etc.) provided for hydroprocessing operations. For example, hydrotreating units and hydrocracking units are examples of hydroprocessing units.

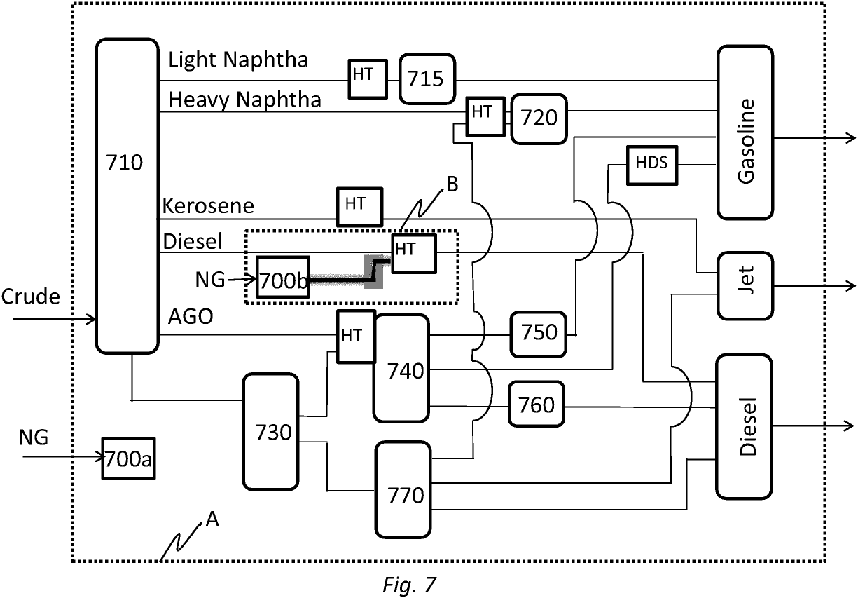

Referring to FIG. 7, there is shown some of the unit operations commonly found in an oil refinery. The crude oil, supplied by a suitable furnace (not shown), is introduced into an atmospheric distillation unit 710, where it is separated into different fractions: atmospheric gas oil (AGO), diesel, kerosene, and naphtha (light and heavy). Light naphtha is directed to an isomerization unit 715 to produce isomerate. Heavy naphtha is directed to a reformer 720 to produce reformate. Residue from the atmospheric distillation process (atmospheric bottoms) is fed to a vacuum distillation unit 730, which produces light vacuum gas oil (LVGO) and heavy vacuum gas oil (HVGO). The AGO and/or LVGO are fed to the FCC 740. The FCC 740 produces, for example, propylene and butylenes, which are fed to an alkylation unit 750. The FCC 250 also produces gasoline (i.e., FCC gasoline) and light cycle oil (LCO). LCO, which is a diesel boiling range product, is a poor diesel fuel blending component without further processing. In FIG. 7, the LCO is fed to a hydrocracker 760, although other approaches to upgrading LCO may be used. The HVGO is fed to the hydrocracker 770, where it is processed into naphtha, kerosene, and/or diesel. The hydrocracker naphtha may contain naphthene, and thus may be converted to high-octane grade gasoline upon catalytic reforming 720. In general, the hydrocracker products may have a low content of sulfur and/or contaminants.

Referring again to FIG. 7, the various outputs from these unit operations/process units may be blended to provide fuels (e.g., finished fuels) and/or be part of various pools for storage (e.g., gasoline, jet fuel, diesel/heating oil). For example, in FIG. 7, isomerate from the isomerization unit 715, reformate from the reformer 720, alkylate from the alkylation unit 750, and FCC gasoline from the FCC 750 may be part of the gasoline pool, while the straight run diesel (i.e., from the atmospheric crude tower 710), the hydrocracked diesel, and the light cycle oil from the FCC may be part of the diesel pool (e.g., after further processing). Depending on the grade, jet fuel can be largely highly refined kerosene. The term “pool”, as used herein, refers to all of the fuel produced by the fuel production process that is ultimately sold as the corresponding fuel pool (e.g., over a given time period). For example, the gasoline pool typically includes all the gasoline boiling range fuels that are ultimately sold as gasoline product, but does not include gasoline boiling range fuels that end up in jet fuel. The fuels that contribute to a pool may have different qualities and/or be stored separately.

In general, the boiling point ranges of the various product fractions (e.g., gasoline, kerosene/jet fuel, diesel/heating oil) may be set by the oil refinery and/or may vary with factors such as the characteristics of the crude oil source, refinery local markets, product prices, etc. For example, without being limiting, the gasoline boiling point range may span from about 35° C. to about 200° C., the kerosene boiling point range may span from about 140° C. to about 230° C., and the diesel boiling point range may span from about 180° C. to about 400° C. Each boiling point range covers a temperature interval from the initial boiling point, defined as the temperature at which the first drop of distillation product is obtained, to a final boiling point, or end point, where the highest-boiling compounds evaporate.

Of course, it will be appreciated by those skilled in the art that the flow diagram of FIG. 7 is representative only. In practice, the unit operations, process units, and/or general configuration may be dependent on the oil refinery, the desired fuel products, and/or advancing technologies. For example, the configuration and/or technology may be dependent upon whether the oil refinery is designed to produce more gasoline or diesel. In general, some oil refineries, e.g., those in the United States, often produce more gasoline than diesel, and thus typically include one or more cat crackers. Without being limiting, a typical U.S. refinery may produce about 60% gasoline-fuel components and about 40% diesel/jet fuel components. In some cases, the gasoline to diesel ratio is seasonal and higher in the summer than the winter to reflect changes in fuel demand.

In addition, although not shown in FIG. 7, a typical oil refinery will include a light ends unit (e.g., for processing the overhead distillate produce from the atmospheric distillation column), and may include units for processing vacuum distillation residues (e.g., the bottom of the barrel), polymerization units, coking units, visbreaking units, tanks, pumps, valves, and so forth. In addition, some of the components illustrated in FIG. 7 may be provided in replicate. For example, there may be multiple, independently operated distillation units. Furthermore, oil refineries typically include various auxiliary facilities (e.g., boilers, wastewater treatments, hydrogen production units, cooling towers, and sulfur recovery units).

Oil refineries typically include numerous hydroprocessing units (e.g., hydrotreaters and/or hydrocrackers), each of which consumes hydrogen at individual rates, purities, and pressures. For example, referring again to FIG. 7, the diesel and kerosene fractions obtained from the atmospheric distillation unit 710 may be treated with a hydrotreater (HT) to obtain diesel blendstock or jet fuel blendstock, whereas naphtha fractions may be hydroprocessed before being sent to the isomerization 715 or catalytic reformer unit 720.

Hydrogen used in these hydroprocessing units may be obtained from a variety of sources. For example, in FIG. 7, the hydrogen is produced by hydrogen production units 700a and 700b. Optionally, some of the hydrogen may also be produced as a by-product of another chemical process (e.g., from reforming unit 720, which when used to produce reformate, also produces hydrogen as a by-product).

In general, the fuel production process includes providing and/or allocating renewable methane or RNG to feed to a hydrogen production unit (e.g., to produce renewable hydrogen). The hydrogen so produced (e.g., renewable hydrogen) is then provided or allocated to a feed used to hydrogenate crude-oil derived liquid hydrocarbon, which ultimately is part of one or more fuels produced by the fuel production facility.

In one embodiment, some of the renewable hydrogen is incorporated into the crude oil derived liquid hydrocarbon. The incorporation of renewable hydrogen into crude oil derived liquid hydrocarbon encompasses the addition, incorporation, and/or bonding of renewable hydrogen to the crude oil derived liquid hydrocarbon. Such reactions include hydrogenation, which includes, without limitation, any reaction in which renewable hydrogen is added to a crude oil derived liquid hydrocarbon through a chemical bond or linkage to a carbon atom. The renewable hydrogen may be bonded to a carbon backbone, a side chain, or a combination thereof, of a linear or ring compound of a crude oil derived liquid hydrocarbon. The addition and/or incorporation of renewable hydrogen into the crude oil derived liquid hydrocarbon may include the addition renewable hydrogen to an unsaturated or a saturated hydrocarbon. This includes addition of renewable hydrogen to unsaturated groups, such as alkenes or aromatic groups, on the crude oil derived liquid hydrocarbon (i.e., the saturation of aromatics, olefins (alkenes), or a combination thereof). The addition and/or incorporation of hydrogen may be accompanied by the cleavage of a hydrocarbon molecule. This may include a reaction that involves the addition of a hydrogen atom to each of the molecular fragments that result from the cleavage. Without being limiting, such reactions may include ring opening reactions and/or dealkylation reactions. Such reactions are known to those of skill in the art. The hydrogenation reactions may be conducted in a “hydrogenation reactor”. As used herein, the term “hydrogenation reactor” includes any reactor in which hydrogen is added to a crude oil derived liquid hydrocarbon. Hydrogenation reactions may be carried out in the presence of a catalyst.

In one embodiment, the renewable hydrogen is added to the crude oil derived liquid hydrocarbon in a hydrotreating process. In one embodiment, the renewable hydrogen is added to the crude oil derived liquid hydrocarbon in a hydrocracking process. In contrast to hydrotreating, which may provide a conversion level less than about 20 wt% (and more typically less than 15 wt%), a hydrocracker may provide a conversion level that is between 20 and 100 wt%. By the term “conversion level”, it is meant the difference in amount of unconverted crude oil derived liquid hydrocarbon between feed and product divided by the amount of unconverted crude oil derived liquid hydrocarbon in the feed. Unconverted crude oil derived liquid hydrocarbon is material that boils above a specified temperature. Without being limiting, for vacuum gas oil, a typical specified temperature may be 343° C. The conditions used in hydrocrackers are conventional and can be readily selected by those of ordinary skill in the art.

In one embodiment, the renewable hydrogen is added to the crude oil derived liquid hydrocarbon in hydroprocessing process that includes hydrogenation, hydrocracking, and/or hydrodesulfurization. In one embodiment, the renewable hydrogen is directed and/or allocated within the fuel production facility (e.g., an oil refinery) such that it preferentially ends up in one or more predetermined fuel products and/or is preferentially consumed in one or more predetermined unit operations.

In one embodiment, the renewable hydrogen is directed and/or allocated within the fuel production facility such that it preferentially ends up in gasoline or a gasoline blending component. The term “gasoline” refers generally to a liquid fuel or liquid fuel component suitable for use in spark ignition engines (e.g., which may be predominantly C₅-C₉ hydrocarbons, and which may boil in the range between 32° C. and 204° C.). For example, the term gasoline can refer to gasoline blending components. In one embodiment, the renewable hydrogen is directed and/or allocated within the fuel production facility such that it ends up in a product that satisfies applicable gasoline specifications (e.g., ASTM D4814).

In one embodiment, the renewable hydrogen is directed and/or allocated within the fuel production facility (e.g., at an oil refinery) such that it preferentially ends up in diesel or a diesel blending component. The term “diesel” refers generally to a liquid fuel or liquid fuel component suitable for use in compression ignition engines (e.g., which may be predominantly C₉-C₂₅ hydrocarbons, and which may boil in the range between 187° C. and 417° C.). For example, the term diesel can refer to diesel blending components. In one embodiment, the renewable hydrogen is directed and/or allocated within the fuel production facility such that it ends up in a product that satisfies applicable diesel specifications (e.g., ASTM D975).

In one embodiment, the renewable hydrogen is directed and/or allocated within the fuel production facility (e.g., at an oil refinery) such that the percentage of renewable hydrogen that ends up in diesel is at least 1.1, 1.2, 1.3, 1.4, or 1.5 times the percentage of fuel produced by the refinery that is diesel. For example, if the fuel production facility produces about 40% diesel and 60% gasoline, more than 44%, 48%, 52%, 56% or 60% of the renewable hydrogen ends up in diesel or diesel blending components.

In one embodiment, the renewable hydrogen is directed and/or allocated to one or more hydrotreaters at the fuel production facility. An oil refinery typically has multiple hydrotreaters. For example, an oil refinery may include a naphtha hydrotreater (e.g., treats heavy naphtha prior to reforming), a kerosene hydrotreater (e.g., removes sulfur and improves smoke point of kerosene), a diesel hydrotreater (e.g., removes sulfur and nitrogen and increases the cetane number of diesel), a vacuum gas oil (VGO) hydrotreater, and/or a resid hydrotreater (e.g., to treat atmospheric residue or vacuum residue). An oil refinery may also include a distillate hydrotreater, which improves the quality of distillate boiling range feedstocks (e.g., uses a feed that includes crude oil derived liquid hydrocarbon in the kerosene and diesel boiling point range). In general, a distillate hydrotreater can treat an individual distillate fraction or a mixture of various distillate fractions, as well as other refinery streams, to meet specifications required for the finished fuel (e.g., sulfur and/or cetane number specifications).

In one embodiment, the renewable hydrogen is directed and/or allocated to one or more hydrocrackers at the fuel production facility. In an oil refinery, hydrocrackers may be used to process gas oil, aromatic cycle oils, and/or coker distillates. These feeds may originate from atmospheric and/or vacuum distillation units, delayed cokers, fluid cokers, visbreakers, or fluid catalytic cracking units. Middle distillates from a hydrocracker usually meet or exceed finished product specifications, but the heavy naphtha from a hydrocracker may be sent to a catalytic reformer for octane improvement. In general, hydrocrackers may be the largest hydrogen consumer in an oil refinery. Using the renewable hydrogen in a hydrocracking process exploits this high demand, and may be advantageous in that more renewable hydrogen may be physically incorporated into the fuel (relative to using the renewable hydrogen in a hydrotreating process for desulfurization where a portion of the renewable hydrogen may be converted to hydrogen sulfide). In one embodiment, the renewable hydrogen is selectively directed and/or allocated to a hydrocracker that produces more diesel than gasoline (i.e., on a volume basis).

In some embodiments, even when all of the renewable hydrogen is directed and/or allocated to a single unit operation, the renewable hydrogen may end up in multiple products and/or coproducts. For example, consider the case where a batch of renewable hydrogen is used in a unit operation that provides cracking (e.g., in a hydrocracker, or in a hydrotreater upstream of a cat cracker), which breaks the longer crude oil derived liquid hydrocarbons chains into smaller molecules, and then separates the product according to boiling point in a distillation tower. In this case, the renewable hydrogen may be incorporated into hydrogen sulfide, LPG, gasoline, kerosene/jet, diesel/heating oil, etc.

In these embodiments, the fuel production process may include allocating the renewable content to one or more of the fuel products. In one embodiment, the renewable content is distributed to all of the products equally. In one embodiment, the renewable content is allocated only to qualifying fuels (i.e., fuels that qualify for incentives under applicable regulations). In one embodiment, the renewable content is allocated to only one qualifying fuel. The approach used to allocate the renewable content to fuel products can be dependent on the applicable regulations and/or the authority providing incentives. In general, the renewable content of the fuel(s) produced, and thus the number and/or value of fuel credits generated, can be dependent on the boundary of the fuel production process. For example, in the configuration illustrated in FIG. 7, the feedstock and/or products change depending on whether the fuel production process is defined by the box labeled A, or the box labeled B.

### Quantifying the Renewable Content

The renewable methane, or hydrogen produced using the renewable methane, is used to produce one or more fuels having renewable content. In one embodiment, the renewable content of one or more fuels produced from the fuel production process is quantified. In general, quantifying the renewable content in the fuel includes determining how much renewable content (e.g., by volume, mass, or energy) is in an amount of the fuel produced (e.g., a batch, which may be expressed as volume, mass, or energy).

Whether some or all of a fuel qualifies as renewable, the method used to quantify the renewable content of the fuel, and/or the carbon intensity of the fuel, can be dependent on applicable regulations (e.g., low carbon fuel regulations and/or renewable energy regulations for the transport sector). For example, various governments have provided legislative measures to promote biofuels and/or reduce GHG emissions from the transport sector. The Government of Canada is developing a Clean Fuel Standard to reduce the lifecycle carbon intensity of fuels and energy used in Canada. The United States has adopted the Renewable Fuel Standard (RFS), a federal program that mandates transportation fuel sold in the U.S. contain a minimum volume of renewable fuels. California’s Air Resource Board (CARB), which is a state agency, provides regulations for the Low Carbon Fuel Standard (LCFS). The United Kingdom is implementing its Renewable Transport Fuel Obligation (RTFO). The European Union has implemented the Renewable Energy Directive (RED), which mandates that a certain percent of all energy in road transport fuels be produced by renewable sources, and the Fuel Quality Directive (FQD), which requires the road transport fuel mix be less carbon intensive than fossil baseline. In many instances, compliance with targets and/or mandates can be demonstrated with fuel credits (e.g., tradable certificates such as RFS’s Renewable Identification Numbers (RINs), LCSF fuel credits, or UK’s Renewable Transport Fuel Certificates (RTFCs)).

Various approaches for quantifying the renewable content, which may be necessary for demonstrating compliance with some regulations (e.g., for quantify renewable fuel volumes) and/or generating fuel credits, have been proposed. For example, some of these methodologies are based on analyzing the products of the fuel production process (e.g., a carbon 14 analysis), while others are based on how much renewably sourced feedstock is used. In respect of the latter, some proposed approaches include (a) the mass balance approach, and (b) the energy content approach (e.g., which may include measuring input and output mass or energy contents, respectively).

In the energy content approach, the energy content is quantified based on energetic weighted ratios of renewable and non-renewable feedstocks. For example, if 50% of the feedstock for the process (by energy) is renewable, then 50% of each product (by energy) can corresponds to renewable content. In the mass balance approach, the quantification of the renewable content is based on the conservation of mass principle (e.g., using the chemistry of the process). For example, one mass balance approach is based on observed yields, and compares the product yields based on co-processing renewable and non-renewable materials to a baseline processing (e.g., using only renewable or non-renewable feedstocks). Another mass balance approach takes into account how much CO, CO₂, and H₂O is produced (e.g., how much carbon does not end up in the product).

In general, one or more approaches for quantifying the renewable content of a fuel may be recommended and/or required for certain regulations. For example, in respect of co-processing crude oil and biogenic oils in an oil refinery process, CARB has considered mass balance approaches based on observed yields (e.g., calculating a yield factor) or carbon mass balance (e.g., taking into account the mass of biogenic feedstock that ends up as CO and/or CO₂). The United Kingdom has proposed using energy content. Germany has proposed using ¹⁴C analysis. The ISCC guidance includes both the mass balance approach and the energy content approach. In any case, new or modified methodologies may be evaluated and/or accepted under the applicable regulations (e.g., for new processes).

In accordance with one embodiment of the instant invention, the renewable content of one or more fuels produced from the fuel production process is quantified by determining how much renewable content (e.g., by volume, mass, or energy) originating from the renewable methane, RNG, and/or renewable hydrogen is in an amount of the fuel produced (e.g., a batch, which may be expressed as volume, mass, or energy). In one embodiment, the renewable content is measured as a mass % (i.e., mass of renewable hydrogen in a batch per total mass of the batch, expressed as a percentage). In one embodiment the renewable content is measured as kg of renewable hydrogen/barrel of fuel. In one embodiment, the renewable content is measured as a volume % (i.e., volume of renewable hydrogen in a batch per total volume of the batch, expressed as a percentage). In one embodiment the renewable content is measured as L of renewable hydrogen/barrel of fuel. In one embodiment, the renewable content is measured as an energy percentage (i.e., energy of renewable hydrogen in a batch per total energy of the batch). In one embodiment, the renewable content is quantified using one of the approaches described in WO 2021/035352, which is hereby incorporated by reference and particularly for the purpose of describing such methodology.

In one embodiment, the renewable content of one or more fuels produced from the fuel production process is determined using a mass balance or energy content approach. Mass balance and energy content approaches to determining renewable content, which can include calculation methods based on chemical reactions in the refining unit, typically require measurements to be taken prior to the start of the process and thereafter (i.e., monitoring of input and output mass or energy content).

In one embodiment, the renewable content of the fuel(s) produced is quantified using energy. For example, in one embodiment, the yield of renewable content (in energy units) for the production of a given fuel is given as

$$\begin{matrix}\text{Yield of renewable content} \left(\text{in energy units}\right) \\ \text{= renewable fraction of feedstock} ∗ \text{energy of fuel produced}\end{matrix}$$

wherein the renewable fraction of feedstock is calculated using energy. In general, the yield of renewable content for a particular fuel can be dependent on the process boundaries used (e.g., the feedstock(s) used and the products produced) and/or how the energy of the renewable hydrogen is allocated.

In one embodiment, the renewable content is quantified using the renewability, as proposed in the “RTFO Guidance Part One Process Guidance”, version January 2020, used for reporting under the Renewable Transport Fuel Obligations Order 2007 No. 3072, which is hereby incorporated by reference and particularly for the purpose of describing such methodology. In this case, the renewability of a fuel refers to the percentage of a fuel (by energy) that is recognized as and/or qualifies as renewable and can be calculated using Eq. (6).

$$\begin{matrix}\text{MJ of renewable fuel =} \\ \frac{\text{Total MJ of renewable feedstocks}}{\text{Total MJ of all feedstocks}} ∗ \text{Total MJ of fuel produced}\end{matrix}$$

In general, using renewability to quantify the renewable content of one or more fuels produced from a feedstock containing renewable methane and a feedstock containing crude-oil derived liquid hydrocarbon may be particularly suitable as part of the energy of the fuel is from renewable sources (e.g., biogas) and part is from non-renewable sources.

In one embodiment, wherein quantifying the renewable content includes using energy of the feedstock(s) and/or product(s), the process includes determining an amount of renewable methane or RNG allocated within the hydrogen production process (e.g., to a portion of the feed converted to syngas), where the portion of the feed that is converted to syngas has a renewable fraction that differs from the renewable fraction of the portion of feed that passes through the methane reformer unconverted.

Since allocating the renewable methane within the hydrogen production process (e.g., to a portion of the feed to the hydrogen production unit that will be converted to syngas) can determine the yield of renewable hydrogen, it can also determine the renewable content of one or more fuels produced using the renewable hydrogen. In some cases (e.g., if it meets applicable sustainability criteria), the renewable portion of a fuel (i.e., the renewable content) may be eligible for fuel credits (e.g., Renewable Transport Fuel Certificates or RTFCs).

In one embodiment, the method includes generating or causing the generation of a fuel credit. In one embodiment, the fuel credit is generated in dependence on the renewable methane and/or renewable hydrogen being used to produce the fuel. In one embodiment, a fuel credit is generated in dependence on the renewable hydrogen being incorporated into the fuel. In one embodiment, a fuel credit is generated in dependence on a calculated renewable content of the fuel product. In one embodiment, the fuel credit is generated in dependence on a magnitude of carbon intensity of the renewable content (i.e., of the renewable hydrogen). In one embodiment, the process includes generating, or causing the generation of, a fuel credit for the renewable portion of the fuel (i.e., the renewable content).

In one embodiment, a renewable fuel credit is generated in dependence on the renewable hydrogen being used to produce a liquid transportation fuel, where the renewable fuel credit is a certificate, record, serial number or guarantee, in any form, including electronic, which evidences production of a quantity of fuel meeting certain lifecycle greenhouse gas emission reductions relative to a baseline set by a government authority. Non-limiting examples of credits include RINs and LCFS credits. A Renewable Identification Number (or RIN) is a certificate that acts as a tradable currency for managing compliance under the RFS. A Low Carbon Fuel Standard (LCFS) credit is a certificate which acts as a tradable currency for managing compliance under California’s LCFS. A RIN has numerical information associated with the production of a qualifying renewable fuel in accordance with regulations administered by the EPA for the purpose of managing the production, distribution and use of renewable fuels for transportation or other purposes. In one embodiment, the process of producing the fuel includes generating or causing the generation of LCFS credits.

### Providing the Fuel Having Renewable Content

In general, the method includes providing one or more fuels having renewable content. In one embodiment, each of the one or more fuel(s) is a finished fuel (e.g., finished gasoline, finished diesel, finished jet fuel, etc.). The term “finished fuel”, as used herein, refers to a mixture of hydrocarbons with or without small quantities of additives, blended to form a fuel suitable for an intended use (e.g., for use in spark-ignition engines or diesel engines). In one embodiment, the fuel provided is a fuel component for blending, which may be used to provide a finished fuel and/or fuel composition. The term “fuel component” or “blending component”, as used herein, refers to any compound or mixture of compounds that is used to formulate a finished fuel or fuel composition. For example, some examples of fuel components include naphtha, kerosene, light gasoil, etc. While a finished fuel may or may not contain small quantities of additives, a fuel composition typically includes one or more additives such as flow improvers, cloud point depressants, antifoam additives, drag reducing additives, stabilizers, corrosion inhibitors, ignition improvers, smoke suppressants, combustion catalysts, etc. The term “fuel”, as used herein, can refer to finished fuels, blending components, and/or fuel compositions.

In general, the fuel can be any suitable fuel including fuel selected from gasoline, diesel, jet fuel, and/or fuel oil. In one embodiment, the fuel produced is jet fuel. In one embodiment, the fuel produced is diesel. In one embodiment, the fuel produced is fuel oil (e.g., a transportation fuel, such as bunker fuel, or heating oil).

In one embodiment, the method includes providing a volume of a fuel having renewable content (e.g., a liquid transportation fuel or blending component of a liquid transportation fuel), where the volume, the renewable content, or a combination thereof is dependent on a calculated renewable content.

In general, since the feedstock to the fuel production process includes renewable feedstock (e.g., RNG) and non-renewable feedstock (e.g., non-renewable natural gas and/or crude oil), a portion of at least one fuel produced from the process can qualify as renewable (e.g., a biofuel) under applicable regulations. However, since the fuel production process does not necessarily produce discrete volumes of fuel that are renewable or non-renewable, the calculated renewable content (e.g., renewability of the fuel) can be used to split the volume of the fuel(s) produced into notional non-renewable and renewable portions and/or to re-assign the renewable content between different consignments of the same fuel or fuel component. This is particularly advantageous when at least part of the fuel is to be shipped and/or when the renewable content of a fuel is required to meet a target value in order to qualify for incentives. For example, consider the case where the fuel production process produces a diesel blending component having a calculated renewable content of 20% (e.g., a renewability of 20%). In this case, ⅕ of a barrel of the diesel blending component can qualify as a renewable fuel, while the remaining ⅘ of the barrel is non-renewable. If the renewable content of the diesel blending component can be reassigned between different consignments under applicable regulations, then the fuel production process can produce:
a) 5 barrels of diesel blending component that is 20% renewable;
b) 1 barrel of diesel blending component that that is 100% renewable and 4 barrels of diesel blending component that is non-renewable; or
c) 4 barrels of diesel blending component that is 25% renewable and 1 barrel of diesel blending component that is non-renewable.
Alternatively, the method can include providing a barrel of finished diesel containing the diesel blending component having renewable content. In each case, the volume of fuel having renewable content, the renewable content, or a combination thereof, is dependent on the calculated renewable content.

In one embodiment, the method includes providing a volume of fuel having renewable content, where the renewable content is less than 100% (e.g., between 1% and 99%, between 2% and 90%, between 3% and 80%, between 4% and 70%, between 50% and 99%, between 15% and 99%, between 20% and 99%, between 25% and 99%, or between 30% and 99%). In one embodiment, the method includes providing a volume of fuel having renewable content, where the renewable content is at least 25%, at least 30, or at least 35%. In one embodiment, the method includes providing a volume of fuel having renewable content, where the renewable content is about 100%.

In one embodiment, the renewable content of the fuel(s) produced has lifecycle greenhouse gas emissions that are at least 50%, at least 60%, at least 65%, or at least 70% lower than lifecycle greenhouse gas emissions of a remaining portion of the fuel composition.

Advantageously, since the calculated renewable content and/or carbon intensity of the fuel(s) produced are calculated in dependence on the renewable methane and/or RNG being allocated within at least one hydrogen production unit (e.g., at the fuel production facility), the volume of the renewable content provided can be increased and/or the carbon intensity can be reduced.

Further advantageously, as described herein, since the feed to SMR (i.e., the feed fed into the reactor tube(s)) can be notionally split into a first portion, which corresponds to feedstock for SMR, and a second portion, which corresponds to fuel for SMR (e.g., is present in the purge stream 95 and is combusted with methane-containing fuel 54), and since the RNG is allocated such that the first portion of the feed fed to the SMR (i.e., the feedstock for SMR) has a higher renewable fraction than the second portion of the feed fed to the SMR (i.e., the fuel for SMR), the yield of renewable hydrogen and/or renewable content of the fuels produced using the renewable hydrogen can be increased (i.e., for a given quantity of renewable methane provided). The dependence of the yield of renewable hydrogen and/or yield of renewable content of fuel produced by the process on the selective allocation of the RNG between feedstock and fuel is advantageous when the renewable content is calculated as renewability.

Of course, the above embodiments have been provided as examples only. It will be appreciated by those of ordinary skill in the art that various modifications, alternate configurations, and/or equivalents will be employed without departing from the scope of the invention. Accordingly, the scope of the invention is therefore intended to be limited solely by the scope of the appended claims.

1. A method of producing fuel comprising:
(a) providing natural gas for a fuel production process, said natural gas comprising renewable natural gas and non-renewable natural gas, said fuel production process comprising reacting hydrogen with one or more reactants, at least a portion of the hydrogen being produced in a hydrogen production unit comprising a steam methane reformer;
(b) providing a feed comprising at least a portion of the natural gas to the steam methane reformer, said feed comprising a first portion that is converted to syngas and a second portion that passes through the steam methane reformer unconverted;
(c) directing the second portion of the feed that passes through the steam methane reformer to one or more burners of the steam methane reformer;
(d) apportioning the renewable natural gas such that the first portion of the feed has a larger renewable fraction than the second portion of the feed, and
(e) producing a volume of fuel having renewable content from the fuel production process, wherein the yield of renewable content is dependent on the first portion of the feed being apportioned a larger renewable fraction than the second portion of the feed.

2. The method according to claim 1, wherein producing the volume of fuel having renewable content comprises combining hydrogen produced from the hydrogen production unit with crude oil derived liquid hydrocarbon in a reactor under conditions to hydrogenate the crude oil derived liquid hydrocarbon.

3. The method according to claim 1, wherein producing the volume of the fuel in step (e) comprises producing a transportation fuel.

4. The method according to claim 1, wherein producing the volume of the fuel in step (e) comprises producing gasoline.

5. The method according to claim 1, wherein producing the volume of the fuel in step (e) comprises producing diesel.

6. The method according to claim 1, wherein producing the volume of the fuel in step (e) comprises producing jet fuel.

7. The method according to claim 1, wherein producing the volume of the fuel in step (e) comprises producing the volume of fuel at an oil refinery.

8. The method according to claim 1, further comprising:
determining a flow rate of the natural gas fed to the steam methane reformer as feed;
determining a flow rate of a purge gas, a product gas, or a combination thereof produced from the hydrogen production unit; and
using the determined flow rates to establish the renewable content of the fuel.

9. The method according to claim 8, further comprising determining an amount of the natural gas provided as feed to the steam methane reformer that is converted to syngas.

10. The method according to claim 9, wherein determining the amount of natural gas that is converted to syngas includes measuring the flow rate of the feed fed to the steam methane reformer and measuring the flow rate of the purge gas, the product gas, or the combination thereof for the hydrogen production unit.

11. The method according to claim 9, wherein the renewable natural gas is apportioned such that a renewable fraction of the natural gas provided as feed to the steam methane reformer is not more than the fraction of the feed fed to the steam methane reformer that is converted to syngas.

12. The method according to claim 1, wherein providing natural gas for the fuel production process comprises withdrawing natural gas from a natural gas distribution system, wherein a portion of the withdrawn natural gas is renewable natural gas.

13. The method according to claim 1, further comprising providing the syngas to a pressure swing adsorption system, wherein step (c) of directing the second portion of the feed that passes through the steam methane reformer to one or more burners of the steam methane reformer comprises feeding the purge gas from the pressure swing adsorption system to the one or more burners of the steam methane reformer.

14. The method according to claim 8, further comprising measuring a composition of the purge gas, said purge gas produced by the pressure swing adsorption system.

15. The method according to claim 1, further comprising apportioning the renewable natural gas to the first portion of the natural gas such that at least 80% of the renewable natural gas is apportioned to the first portion.

16. The method according to claim 1, wherein the method comprises apportioning the renewable natural gas to the first portion of the natural gas such that substantially all of the renewable natural gas is apportioned to the first portion.

17. The fuel having renewable content produced by the method according to claim 1.

18. (canceled)

19. A method comprising:
(a) providing natural gas that is processed in a hydrogen production unit to produce hydrogen, said hydrogen production unit comprising steam methane reforming, said natural gas comprising renewable natural gas and non-renewable natural gas,
said hydrogen used in a fuel production process for producing one or more fuels, said fuel production process comprising:
(i) combining hydrogen produced from the hydrogen production unit with crude oil derived liquid hydrocarbon in a reactor under conditions to hydrogenate the crude oil derived liquid hydrocarbon, and
(ii) providing a liquid transportation fuel comprising the hydrogenated crude oil derived liquid hydrocarbon,
said natural gas provided as feed for the steam methane reforming, said feed comprising a first portion that is converted to syngas and a second portion that passes through the steam methane reforming unconverted;
(b) apportioning the renewable natural gas such that the first portion of the feed has a larger renewable fraction than the second portion of the feed; and
(c) establishing a renewable content of the liquid transportation fuel in dependence on step (b), said establishing comprising:
(i′) determining a flow rate of the natural gas fed to the hydrogen production unit as feed; and
(ii′) determining a flow rate of a purge gas, a product gas, or a combination thereof produced by the hydrogen production unit.

20. A method of producing one or more fuels comprising:
(a) providing natural gas for a fuel production process, said natural gas comprising renewable methane and non-renewable methane, said fuel production process comprising reacting hydrogen with crude oil derived liquid hydrocarbon, at least a portion of the hydrogen being produced from a hydrogen production unit comprising a steam methane reformer;
(b) determining a flow rate of the natural gas fed to the steam methane reformer as feed;
(c) determining a flow rate of a purge gas, a product gas, or a combination thereof produced from the hydrogen production unit; and
(d) producing a volume of fuel having renewable content from the fuel production process,
wherein the natural gas fed to the steam methane reformer as feed includes a first portion that is converted to syngas and a second portion that passes through the steam methane reformer unconverted, and
wherein the volume of the fuel, a renewable content of the fuel, or a combination thereof, is dependent on the flow rates determined in step (b) and (c) and on the first portion being apportioned a higher renewable fraction than the second portion.

21-38. (canceled)

39. A method of producing renewable hydrogen comprising:
(a) providing natural gas for a hydrogen production process, said natural gas comprising renewable natural gas and non-renewable natural gas, said hydrogen production process comprising methane reforming said hydrogen production process comprising methane reforming;
(b) providing a feed comprising at least a portion of the natural gas to the methane reforming, said feed comprising a first portion that is converted to syngas and a second portion that passes through the methane reforming unconverted;
(c) directing the second portion of the feed that passes through the methane reforming unconverted to one or more burners as fuel for the methane reforming;
(d) apportioning the renewable natural gas such that the first portion of the feed has a larger renewable fraction than the second portion of the feed, and
(e) producing a volume of hydrogen having renewable content from the hydrogen production process, wherein the yield of renewable content is dependent on the first portion of the feed being apportioned a larger renewable fraction than the second portion of the feed.

40. The method according to claim 39, wherein the methane reforming comprises steam methane reforming.

41. The method according to claim 39, wherein the volume of hydrogen produced in step (e) is provided as a transportation fuel.

42. The method according to claim 39, wherein the volume of hydrogen produced in step (e) is provided for use in producing a transportation fuel.

43. The method according to claim 42, wherein producing the transportation fuel comprises gasoline, diesel, jet fuel, or any combination thereof.

44. The method according to claim 39, wherein the volume of hydrogen produced in step (e) is produced at an oil refinery.

45. The method according to claim 39, further comprising:
determining a flow rate of the natural gas fed to the methane reforming as feed;
determining a flow rate of a purge gas, a product gas, or a combination thereof produced from the hydrogen production unit; and
using the determined flow rates to establish the renewable content of the hydrogen.

46. The method according to claim 39, further comprising determining an amount of the natural gas provided as feed to the methane reforming that is converted to syngas.

47. The method according to claim 46, wherein determining the amount of natural gas that is converted to syngas includes measuring the flow rate of the feed fed to the methane reforming and measuring the flow rate of the purge gas, the product gas, or the combination thereof for the hydrogen production unit.

48. The method according to claim 46, wherein the renewable natural gas is apportioned such that a renewable fraction of the natural gas provided as feed to the methane reforming is not more than a fraction of the feed fed to the methane reforming that is converted to syngas.

49. The method according to claim 39, wherein the hydrogen production process comprises pressure swing adsorption, and wherein step (c) of directing the second portion of the feed that passes through the methane reforming to the one or more burners comprises feeding purge gas from the pressure swing adsorption system to the one or more burners.

50. The method according to claim 49, further comprising measuring a composition of the purge gas.

51. The method according to claim 39, further comprising apportioning the renewable natural gas to the first portion of the natural gas such that at least 80% of the renewable natural gas is apportioned to the first portion.

52. The method according to claim 39, wherein the method comprises apportioning the renewable natural gas to the first portion of the natural gas such that substantially all of the renewable natural gas is apportioned to the first portion.

53. The method according to claim 39, wherein providing natural gas for the hydrogen production process comprises withdrawing natural gas from a natural gas distribution system, wherein a portion of the withdrawn natural gas is renewable natural gas.
